(19) United States
(12) Patent Application Publication
(10) Pub. No.: US 2025/0101606 A1
(43) Pub. Date: Mar. 27, 2025

(54) SYSTEM AND METHOD FOR PURIFICATION OF GASSES SUCH AS FUEL GASSES

(71) Applicants: Danmarks Tekniske Universitet, Kongens Lyngby (DK); Elplatek A/S, Espergærde (DK)

(72) Inventors: Sebastian Nis Bay Villadsen, Kongens Lyngby (DK); Philip Loldrup Fosbøl, Kongens Lyngby (DK); Jan Boye Rasmussen, Espergærde (DK)

(21) Appl. No.: 18/291,396

(22) PCT Filed: Aug. 8, 2022
(86) PCT No.: PCT/EP2022/072258

§ 371 Date: Jan. 23, 2024

(30) Foreign Application Priority Data
Aug. 6, 2021 (EP) 21190147.5
Jun. 7, 2022 (EP) 22177586.9

(51) Int. Cl. C25B 1/46; B01D 53/14; B01D 53/52; B01D 53/75; B01D 53/78; C25B 15/08

(52) U.S. Cl. CPC C25B 1/46; B01D 53/1425; B01D 53/1468; B01D 53/52; B01D 53/75; B01D 53/78; C25B 15/087; B01D 2251/304; B01D 2258/05

(57) ABSTRACT

The present disclosure provides a system and a method for cleaning of gas.

### TECHNICAL FIELD

The present disclosure relates to desulfurisation of gasses.

### BACKGROUND

The majority of biogas plants use either activated carbon, iron chloride, or a biological scrubbing system for removal of H₂S. Biogas desulfurization is required, no matter the downstream application, due to the harmful properties of H₂S. These include corrosion, health issues, and inactivation of catalysts by H₂S.

While other desulfurization technologies removes sulfide downstream of the digester once it has transformed to H₂S, the iron chloride process removes the sulfide inside the digester. Iron salt, most often iron chloride, is added to the digester in a solution, which limits the H₂S production through the formation of iron-sulfides. While the primary advantage of this technology is the lack of capital expenditure, as the dosing of the liquid FeCl₂ can be done in a simple way compared to the construction of scrubbers, the disadvantage is the high operating expense, as FeCl₂ has to be continuously added to the digester.

Activated carbon, or impregnated activated carbon, has found application within odor control and gas purification. The ability to remove impurities down to very low levels, makes the activated carbon a widely used technology for polishing or trace amount desulphurization. However, the price of activated carbon during operation makes it an expensive choice for bulk desulphurization, and when saturated, the activated carbon needs either to be regenerated or exchanged leading to substantial expenses.

The operational expenses associated with H₂S removal using a biological scrubber are lower compared to the two alternatives above. The sulfur eating bacteria requires only nutrients and air to remove the H₂S. Therein, however, lies one of the weaknesses of the process, as the addition of air results in an increased oxygen (O₂) content in the downstream biogas. This is a serious issue for biogas plants with upgrading facilities, as the natural gas grid only allows for very low levels of O₂. Another issue with the biological scrubbing systems are the lack of flexibility, as both too little and too much H₂S will kill the bacteria. The lack of flexibility combined with the addition of oxygen to the cleaned biogas results in unwanted downtime.

Chlorine-based bleaches have also been used for desulfurization of gasses. However, the use of hypochlorite can introduce undesired chlorine into the gas, effectively replacing one undesired contaminant for another. The operation parameters are especially sensitive to the amount of H₂S in the gas to be purified, requiring constant monitoring and adjustment in response to the H₂S content in order to achieve effective desulfurization of the gas, and to avoid introduction of undesired chlorine. These plants may also suffer from high operational costs due to the need for continuous addition of bleach.

### SUMMARY

The present disclosure describes a system and a method for cleaning of gas, such as fuel gasses. Particularly, the disclosure provides a system and a method for desulfurization of gases. The disclosed invention has a low operating cost, in part because it requires relatively small volumes of liquid for its operation compared to the volume of the gas purified and/or the amount of contaminant removed from said gas. This is achieved by recycling and regeneration the scrubbing liquid electrochemically. The system is also capable of using inexpensive reagents for desulfurization, further contributing to the low operation expenses. Furthermore, because the system is capable of regenerating the desulfurization agent, it is less dependent on continuous maintenance.

One aspect of the present disclosure provides for a system for desulfurisation of gas, said system comprising:
i. an electrolysis element comprising separate anolyte- and catholyte compartments for generation of an anolyte and a catholyte, respectively, and
ii. a wet scrubbing element comprising:
   a gas inlet and a gas outlet defining the direction of the gas flow;
an anolyte inlet and a catholyte inlet, wherein the catholyte inlet is separate and downstream from the anolyte inlet relative to the direction of the gas flow; and
   one or more scrubbing liquid outlets
      said one or more scrubbing liquid outlets at least in part supplying the electrolysis element.

One aspect of the present disclosure provides a system, wherein:
i. the system comprises a first scrubbing element and a second scrubbing element,
ii. the anolyte compartment supplies a first scrubbing element at its anolyte inlet,
iii. the catholyte compartment supplies a second scrubbing element at its catholyte inlet,
iv. the liquid outlet of the first scrubber element supplies the electrolysis element and the anolyte inlet of the first scrubbing element, and
v. the liquid outlet of the second scrubbing element supplies the electrolysis element and the catholyte inlet of the second scrubbing element.

One aspect of the present disclosure provides for a method of desulfurising gas, said method using the system disclosed herein.

On aspect of the disclosure provides for a method for desulfurisation of gas, said method comprising the steps of
i. providing an electrolysis element comprising separate compartments for generation of an anolyte and a catholyte,
ii. providing one or more wet scrubbing elements,
iii. providing a scrubbing liquid comprising an alkali chloride,
iv. providing a gas comprising a sulfur compounds,
v. conducting a electrochemical conversion of said scrubbing liquid to produce a anolyte comprising an oxidising agent and a catholyte comprising a base,
vi. conducting a first scrubbing of said gas by contacting said gas with said anolyte in one wet scrubbing element, thereby obtaining a desulfurised gas and a spent scrubbing liquid, and conducting a second scrubbing of said gas by contacting said gas with said catholyte, thereby obtaining a desulfurised and dechlorinated gas and a spent scrubbing liquid, wherein the second scrubbing is conducted downstream of the first scrubbing relative to the direction of the gas flow.
vii. recycling the spent scrubbing liquid by
   a. supplying at least parts of the spent scrubbing liquid to the electrolysis element

In one further aspect of the disclosure, step vii. further comprises a step of:
b. supplying at least parts of the spent scrubbing liquid directly to the wet scrubbing elements by bypassing the electrolysis element.

One aspect of the present disclosure provides for a fuel gas processing plant comprising the system as disclosed herein.

One aspect of the disclosure provides for a system configured for performing the method as disclosed herein.

### DESCRIPTION OF DRAWINGS

FIG. 1: System comprising an electrolysis element 101 with separate compartments for generation of anolyte 108 and catholyte 109, said catholyte 109 supplying a wet scrubbing element 102, wherein the liquid outlet of said wet scrubbing element 102 is fed via pump 111 in part back to wet scrubbing element 102 via bypass 105 and in part back to electrolysis element 101. Catholyte 109 from electrolysis element 101 is fed to pump 111. Said system also comprises a gas flow 112 through said wet scrubbing element 102.

FIG. 2: System comprising a electrolysis element 201 with separate compartments for generation of anolyte 208 and catholyte 209, wherein said anolyte 208 is fed to a first wet scrubbing element 203, said liquid outlet of wet scrubbing element 203 being fed via pump 211a in part to the electrolysis element 201 and in part to the first wet scrubbing element 203 via bypass 206. A second liquid circuit comprising an aqueous solution 213 which is fed to a second wet scrubbing element 204 by pump 211b. Said aqueous solution is for example water or an aqueous solution of an alkali hydroxide. Said system comprises a gas flow 212 first through the first wet scrubbing element 203 and subsequently through the second wet scrubbing element 204.

FIG. 3: A system comprising a gas 312 fed through wet scrubbing element 302. The system further comprises an electrolysis element 301 generating a liquid 310 comprising anolyte and catholyte, which is fed to wet scrubbing element 302. The liquid outlet of wet scrubbing element 302 is fed via a pump 311a in part back to wet scrubbing element 302 via bypass 306 and in part back to electrolysis element 301. The system further comprises a second liquid circuit comprising an aqueous solution that is for example water or an aqueous alkali hydroxide. Via pump 311b, this liquid circuit is fed into the wet scrubbing element 302 at a position downstream of the introduction of liquid 310, relative to the direction of the flow of the gas 312.

FIG. 4: A system comprising a gas 412 which is fed through a wet scrubbing element 402. An electrolysis element 401 generates liquid 410 comprising anolyte and catholyte, which is fed to wet scrubbing element 402. The liquid outlet of wet scrubbing element 402 is in part fed to pump 411a, which in part supplies the electrolysis element 401 and in part supplies the wet scrubbing element 402 via bypass 406. The liquid outlet of wet scrubbing element 402 in part also supplies pump 411b, which supplies wet scrubbing element 402 at a position downstream of where electrolysis element 401 supplies wet scrubbing element 402, relative to the direction of the flow of gas 412 through wet scrubbing element 402.

FIG. 5: A system comprising a gas flow 512, wherein the gas first passes a first wet scrubbing element 503 and the passes a second wet scrubbing element 504. The system further comprises an electrolysis element 501 which produces an anolyte 508 which is few to the first wet scrubbing element 503. The liquid outlet of the first wet scrubbing element 503 is fed via pump 511a in part back to electrolysis element 501 and in part via a first bypass 506 back to the first wet scrubbing element 503. The electrolysis element 501 further produces a catholyte 509 which is fed to the second wet scrubbing element 504. The liquid outlet from the second wet scrubbing element 504 is fed via pump 511b in part back to the electrolysis element 501 and in part via a second bypass 507 back to the second wet scrubbing element 504.

FIG. 6: A system comprising a gas flow 612 which first passes through a first wet scrubbing element 603 and the passes through a second wet scrubbing element 604. The system further comprises an electrolysis element 601 which produces a liquid 610 comprising anolyte and catholyte, said liquid being fed to the first wet scrubbing element 603. The liquid outlet of the first wet scrubbing element 603 is fed via pump 611a to the second wet scrubbing element 604. The liquid outlet of the second wet scrubbing element 604 is fed via pump 611b in part back to the electrolysis element 601 and in part via bypass 605 to the first wet scrubbing element.

FIG. 7: Current employed to electrochemical cell for removal of H₂S as a function of gas flow.

FIG. 8: H₂S in output gas as a function of current employed. H₂S inlet flow: 500 ppm; gas flow: 300 g/h; liquid flow: 500 L/h. 50 g/L NaCl. At 0.8 A, the concentration of H₂S was approximately 10-13 ppm. At 1.2 A, the concentration of H₂S was approximately 3 ppm.

FIG. 9: Content of H₂S in gas as a function of solvent flow. The content of H₂S was 5 to 8 ppm over the entire range of solvent flows (50 to 500 L/h).

FIG. 10: H₂S content in gas outlet from scrubber 1 (S1) as a function of time (0 to 1 ppm). Cl₂ content in outlet gas from scrubber 1 as a function of time (9 to 13 ppm). Cl₂ in scrubber 2 (S2) liquid as a function of time (start: 0 ppm; end: 20 ppm (sensor saturated)).

FIG. 11: Cl₂ content in gas outlet from scrubber 1 and scrubber 2 as a function of time. Outlet from scrubber 1 is 300-500 ppm. Outlet from scrubber 2 is approximately 0 ppm until 6 h, then increase to 300 ppm at 7 h.

FIG. 12: pH of second scrubber liquid as a function of time in scrubber liquid of scrubber 2 (tap water). At 0 h: pH approximately 6.5. At 6 h: pH approximately 3.0.

FIG. 13: Content of Cl₂ in outlet gas from scrubber 1 and scrubber 2. Scrubber 1: start: approximately 100 ppm; 8 h: approximately 400 ppm. Scrubber 2: approximately 0 ppm throughout.

FIG. 14: System comprising a electrolysis element 1401 with separate compartments for generation of anolyte 1408 and catholyte 1409, wherein said anolyte 1408 is fed to a first wet scrubbing element 1403, said liquid outlet of wet scrubbing element 1403 being fed in part to the electrolysis element 1401 by pump 1411c and in part to the first wet scrubbing element 1403 by pump 1411a via bypass 206. A second liquid circuit comprising an aqueous solution 1413 which is fed to a second wet scrubbing element 1404 by pump 1411b. Said aqueous solution is for example water or an aqueous solution of an alkali hydroxide. Said system comprises a gas flow 1412 first through the first wet scrubbing element 1403 and subsequently through the second wet scrubbing element 1404.

FIG. 15: System comprising a first wet scrubbing element 1503 and a second wet scrubbing element 1504, said system comprises a gas flow 1512 first through the first wet scrubbing element 1503 and subsequently through the second wet scrubbing element 1503.

FIG. 16: Biogas containing H₂S enters the scrubber (A), through the bottom at flow G1, where it is mixed with the solvent containing active chlorine (e.g. hypochlorite), which is pumped (P1) through flow 4 and then sprayed through a nozzle into the scrubber. Thereby the H₂S is oxidized to sulfur and the cleaned biogas leaves through the top of the scrubber via G2 where the H₂S contents are measured at (D). The solvent leaves through the bottom of the scrubber, where it is pumped (P2) through flow 1 into the electrochemical cell (C). The spent solvent is then regenerated by applying electrical current through the electrochemical cell. The liquid flowing through the cell (Flow 2 and 3) enters the reservoir underneath the scrubber. The hydrogen produced at the cathode is vented (G3). AP1-4 indicates the location of pH and ORP sensors.

FIG. 17: Effect of solvent flow on outlet H₂S concentration at constant current, gas flow and H₂S inlet concentration.

FIG. 18: Applied current needed for H₂S removal for different total gas flows at the same H₂S concentration. Data labels show the removal efficiency of the process.

FIG. 19: Calculated current efficiency for the scrubber system, for different total gas flows and H₂S concentrations.

FIG. 20: Long term test of the electroscrubbing system of Example 14.

FIG. 21: Accumulated Amount of sulphate in the liquid phase of the system, compared to the total amount of H₂S removed from the gas phase for the long term experiment.

FIG. 22: Concentration of H₂S (left columns) and oxidant (right columns) in outlet gas as a function of applied current.

FIG. 23: Faraday efficiency as a function of current and gas flow.

FIG. 24: Faraday Efficiency as a function of amount of H₂S and gas flow rate.

FIG. 25: Concentration of H₂S as a function of solvent flow rate. Current was kept constant.

FIG. 26: Faraday efficiency as a function of current.

FIG. 27: Overview of the set-up used in Example 17.

FIG. 28: Results from experiment A of example 17, removal of hydrogen sulfide with constant current.

FIG. 29: Results from experiment B of Example 17, removal of hydrogen sulfide with different applied currents.

### DETAILED DESCRIPTION

### Definitions

By “electrolysis element” is meant an element capable of consuming electrical energy to convey a chemical change in a chemical composition. An electrolysis element includes electrochemical cells, electrolytic cells, such as electrolytic diaphragm cells.

By chlorine is meant Cl_{2′} unless otherwise specified.

By hypochlorite is meant the ion ClO⁻, which may be present in an aqueous solution together with a suitable counter ion, for example H⁺ or Na⁺.

As used herein, once a scrubbing liquid has been passed through a wet scrubbing element, it is termed a “spent scrubbing liquid”. However, such liquid may still possess capacity for performing wet scrubbing. As used herein “Scrubbing liquid” comprises “spent scrubbing liquid”, “anolyte” and “catholyte”. “Spent scrubbing liquid” may comprise components found in the anolyte and the catholyte, and may thus still have some capacity for carrying out the wet scrubbing disclosed herein.

By “desulfurisation” is meant a reduction in the content of sulfur compounds, such as a reduction of H₂S content.

As used herein, “gas” comprises gases that are substantially a single type of compound and also mixtures of two or more gasses. The gasses may comprise one or more contaminants, such as one or more sulfur compounds. The gasses disclosed herein are preferably gasses in the temperature range of 0 to 100° C.

It is contemplated that whenever a sodium ion species, such as NaCl, NaOH, or NaClO, as described herein, such species may be substituted with the corresponding species of other alkali metals or earth alkali metals, such as potassium, lithium, or calcium or other cationic species such as other metal ions, other inorganic cations, and organic cations. The term “organic cation” refers to a cation comprising carbon. The cation may comprise further elements, for example, the cation may comprise hydrogen, nitrogen or oxygen. The term “inorganic cation” includes any metal cations, including the s-block metals, d-block metals, and p-block metals, and ammonium. Exemplary species suitable to carry out the disclosed invention is NaCl, NaOH, NaClO, KCl, KOH, KClO, LiCl, LiOH, LiClO, MgCl₂, Mg(OH)₂, Mg(OCl)₂, CaCl₂, Ca(OH)₂, Ca(OCl)₂, BaCl₂, Ba(OH)₂, Ba(OCl)₂. That is, it is the anionic species that aids in the desulfurisation of gasses as disclosed herein. The cationic species (Na⁺, K⁺, Li⁺, etc.) are considered spectator ions, and can be substituted for other cationic species which do not negatively effect the desulfurisation of the gas.

### Electrolysis Element

As used herein, the term “electrolysis element” refers to any element capable of carrying out electrolysis of an aqueous liquid, such as an aqueous solution. Specifically, such electrolysis is the conversion of one or more chemical components of the aqueous solution to one or more other chemical components, said conversion being carried out using electrical energy. In a specific embodiment, the electrolysis element is an electrochemical cell.

The electrolysis element of the present disclosure comprises two electrodes: the anode carries out oxidation of the one or more chemical components of said aqueous solution to produce an anolyte; the cathode carries out reduction of one or more chemical components of said aqueous solution to produce a catholyte. One embodiment of the present disclosure provides for an electrolysis element comprising separate compartments for generation of anolyte and catholyte. Such construction allows for anolyte and catholyte to be separately obtained from said electrolysis element. The electrolysis element of the present disclosure alternatively provides for an electrolysis element comprising a single compartment for generation of anolyte and catholyte. Such constructions allows for obtaining the anolyte and catholyte as a mixture.

The electrolysis element of the present disclosure may comprise separate liquid inlets to the anolyte and catholyte compartments. This construction allows for introduction to the catholyte compartment of a liquid already enriched in a chemical species which is produced in the catholyte compartment. For example, as disclosed herein, the cathode may produce hydroxide ions as a chemical species. If a liquid already enriched in hydroxide ions is introduced to the catholyte compartment, said liquid may be further enriched in hydroxide ions. This construction also allows for introduction to the anolyte compartment of a liquid already enriched in a chemical species which is produced in the catholyte compartment. For example, as disclosed herein, the anode may produce chlorine as a chemical species. If a liquid already enriched in chlorine is introduced to the anolyte compartment, said liquid may be further enriched in chlorine. Thus, in one embodiment of the present disclosure, the electrolysis element comprises separate liquid inlets to the anolyte and catholyte compartments.

The electrolysis element of the present disclosure may comprise a liquid inlet supplying both the anolyte and the catholyte compartments. This construction allows for introduction to the catholyte compartment and/or the anolyte compartment of a liquid already enriched in either of a chemical species generated at the cathode and/or a chemical species generated at the anode to be further enriched in any of such chemical species. This construction also allows for introduction of liquid comprising a compound which is converted by both the anode and the cathode. By way of example, an aqueous solution of NaCl would be converted to an aqueous solution of chlorine at the anode, whereas it would be converted to an aqueous solution of sodium hydroxide at the cathode. Thus, in one embodiment of the present disclosure, the electrolysis element comprises one liquid inlet.

In one embodiment of the present disclosure, the electrolysis element is an electrolytic cell for conducting an electrochemical process wherein an electrolyte is passed through a microporous diaphragm that separates the anolyte and catholyte compartments of the cell. In response to an electrical field that is generated between an anode contained in the anolyte compartment and a cathode contained in the catholyte compartment, the electrolyte is dissociated to synthesize other chemical materials, e.g., inorganic materials. In one aspect, the electrolytic cell is a chloralkali diaphragm cell wherein, for example, aqueous sodium chloride brine undergoes electrolysis to produce sodium hydroxide in the catholyte compartment and chlorine gas in the anolyte compartment.

As used herein, Nm³/h means normal cubic meters per hour. By “normal” is meant under standard conditions, e.g. at 1 atm and 0° C. Whenever, a parameter is designated in Nm³/h, it is also intended that said parameter is given in m³/h.

In one embodiment, the electrolysis element comprises one liquid inlet configured to supply the anolyte compartment and another liquid inlet supplying the catholyte compartment.

### Anolyte

The anolyte as disclosed herein comprises an oxidising agent. In one embodiment, the oxidising agent is produced in the anolyte compartment of the electrolysis element. In one embodiment of the present disclosure, the oxidising agent is a chlorine-based bleaching agent. In a specific embodiment, the oxidising agent is capable of oxidising H₂S to sulfur of at least oxidation number 0, such as elemental sulfur. In another embodiment, the oxidising agent is capable of oxidising H₂S to sulfur having an oxidation number higher than 0, such as +2, +4, or +6. In one embodiment, the oxidising agent is capable of oxidising H₂S to sulfate, such as sulfate ions. In one embodiment of the present disclosure, the oxidising agent is chlorine. In aqueous solution, chlorine undergoes conversion to other species by reaction with water. Such species are for example hypochlorite. In one embodiment, the oxidising agent is hypochlorite ions. In a particular embodiment of the present disclosure, the oxidising agent is a mixture of chlorine and hypochlorite ions. In one embodiment of the present disclosure, the anolyte is generated from aqueous sodium chloride.

### Catholyte

The catholyte as disclosed herein comprises a compound capable of removing chlorine a gas, for example by scrubbing the gas and/or converting the chlorine to another chemical species. The catholyte is generated in the catholyte compartment of the electrolysis element. Suitable catholyte components include hydroxide ions. In one embodiment, the catholyte comprises hydroxide ions, for example as sodium hydroxide, potassium hydroxide, lithium hydroxide or other alkali hydroxides, magnesium hydroxide, calcium hydroxide, barium hydroxide, or other earth alkali hydroxides, or hydroxides of d-block elements or hydroxides of p-block elements. Hydroxide ions react with chlorine to produce hypochlorite ions. In one embodiment of the present disclosure, the catholyte is generated from aqueous sodium chloride.

As disclosed in the examples herein, the presence of hydroxide ions in the catholyte effects efficient removal of chlorine from the gas. The reaction is stoichiometric with respect to hydroxide ions and chlorine. The reaction proceeds even at low concentration of hydroxide ions.

### Wet Scrubbing Element

The wet scrubbing element as disclosed herein is capable of facilitating a high surface area contact between a liquid and a gas, thereby facilitating transfer of certain chemical components from said gas to said liquid (scrubbing liquid). Such chemical components may be sulfur compounds (e.g. H₂S). Furthermore, reactive species in the scrubbing liquid may react with chemical components of the gas, thereby further facilitating transfer to the scrubbing liquid. This is for example achieved by conversion from chemical species that are gaseous to chemical species that are not, such as solid, liquid, or ionic species.

In one embodiment of the present disclosure, the wet scrubbing element is a wet scrubbing tower. The wet scrubbing tower may have any suitable configuration that allows for contact between the gas and the scrubbing liquid. Wet scrubbing towers will typically be packed with a packing material or comprise an internal structure, both of which can facilitate dispersion of the scrubbing liquid to provide a high surface contact between said liquid and the gas. The present inventors contemplate that other means facilitating the contact of the liquid and the gas may also be used in the system of the present disclosure.

In one embodiment of the present disclosure, the gas is supplied essentially at the bottom of the wet scrubbing tower at a gas inlet and let out essentially at the top of the wet scrubbing tower at a gas outline. This creates a counter flow between the ascending gas the descending scrubbing liquid, which can improve the scrubbing efficiency.

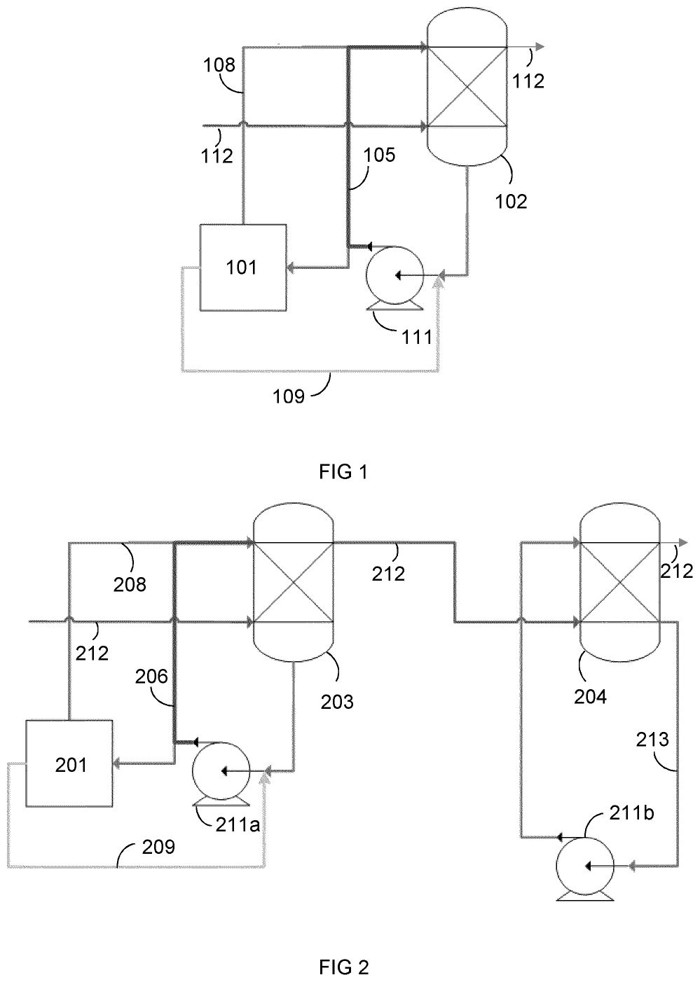

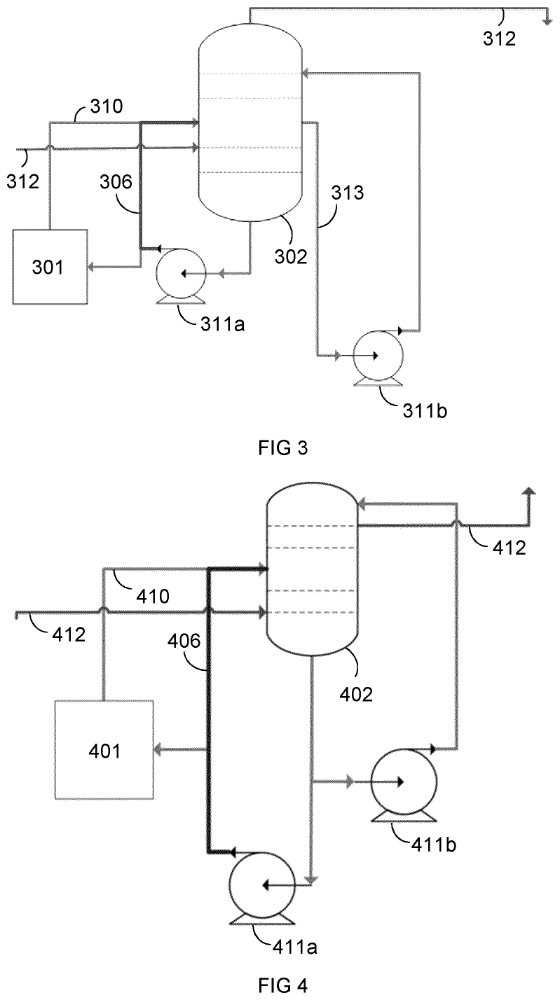

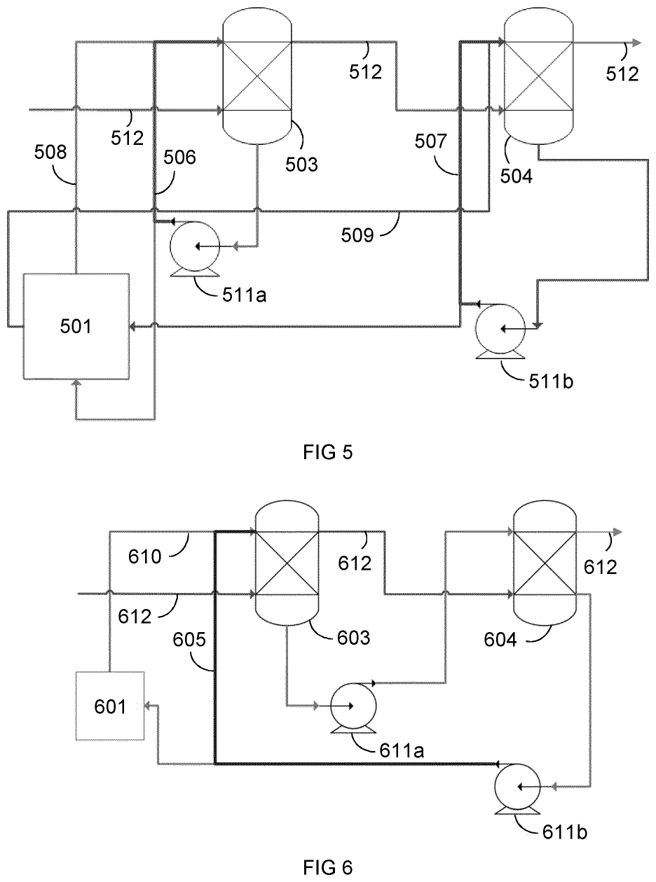

In one embodiment of the present disclosure, the anolyte is supplied to the scrubbing tower via an anolyte inlet. In one embodiment, the catholyte is supplied to the scrubbing tower via a catholyte inlet. In one embodiment, the scrubbing tower comprises one or more scrubbing liquid outlets. One embodiment provides for a configuration of anolyte and catholyte inlets and scrubbing liquid outlets as shown in FIG. 1. One embodiment provides for a configuration of anolyte and catholyte inlets and scrubbing liquid outlets as shown in FIG. 2. One embodiment provides for a configuration of anolyte and catholyte inlets and scrubbing liquid outlets as shown in FIG. 3. One embodiment provides for a configuration of anolyte and catholyte inlets and scrubbing liquid outlets as shown in FIG. 4. One embodiment provides for a configuration of anolyte and catholyte inlets and scrubbing liquid outlets as shown in FIG. 5. One embodiment provides for a configuration of anolyte and catholyte inlets and scrubbing liquid outlets as shown in FIG. 6. One embodiment provides for a configuration of anolyte and catholyte inlets and scrubbing liquid outlets as shown in FIG. 14.

In one embodiment of the present disclosure, the catholyte inlet is positioned downstream of the anolyte inlet relative to the direction of the gas flow.

In one embodiment, the system of the present disclosure comprises two wet scrubbing towers, wherein the anolyte inlet and catholyte inlets are position on separate wet scrubbing towers, and wherein the catholyte inlet is position on the tower downstream of the tower on which the anolyte inlet is positioned, relative to the direction of the flow of the gas through the two wet scrubbing towers.

A part of the catholyte may be introduced together with the anolyte liquid. Specifically, in one embodiment of the present disclosure, 1 to 10%, 10 to 20%, 20 to 30%, 30 to 40%, 40 to 50%, 50 to 60%, 60 to 70%, 70 to 80%, 80 to 90%, or 90 to 100% of the catholyte liquid may be introduced at the anolyte inlet.

The wet scrubbing elements, e.g. the wet scrubbing towers, of the present disclosure comprises one or more scrubbing liquid outlets. In one embodiment of the present disclosure, the scrubbing liquid outlet is positioned essentially at the bottom of the wet scrubbing element. In one embodiment of the present disclosure, the wet scrubbing element comprises a scrubbing liquid outlet between the catholyte inlet and the anolyte inlet. In one embodiment, the wet scrubbing element comprises a scrubbing liquid outlet between the catholyte inlet and the anolyte inlet and a scrubbing liquid outlet below the anolyte inlet.

In one embodiment, the system of the present disclosure comprises two wet scrubbing elements, wherein the first wet scrubbing element comprises an anolyte inlet and a scrubbing liquid outlet, and the second wet scrubbing element comprises a catholyte inlet and a scrubbing liquid outlet.

### Scrubbing Liquid

The scrubbing liquid of the present disclosure is generated from a suitable aqueous composition. In one embodiment, the scrubbing liquid comprises or is generated from a liquid comprising chloride ions. In one embodiment, the source of the chloride ions is a chloride salt. The chloride salt may be any suitable chloride salt. In one embodiment, the cation in the chloride salt is an inorganic cation. In one embodiment, the cation is a metal cation. In one embodiment, the metal of the metal cation is an s-block metal, a d-block metal, or a p-block metal. In one embodiment, the cation is an ammonium cation. In one embodiment the cation is an organic cation, such as a monoalkyl, dialkyl, trialkyl, or tetraalkyl ammonium ion. In one embodiment, the cation comprises carbon. In a further embodiment, the cation further comprises other elements than carbon, for example, the cation may comprise hydrogen, nitrogen or oxygen. In on embodiment, the cation is chosen so that it does not interfere with the electrochemical reactions and/or redox reactions occurring in the system of the disclosure, e.g. the cation is a spectator ion. In one embodiment, the chloride salt is soluble in aqueous solution. In one embodiment of the present disclosure, the cation is selected from Li⁺, Na⁺, K⁺, Mg²⁺, Ca²⁺, Sr²⁺, Ba²⁺ and metal ions of the d-block and metal ions of the p-block.

In one embodiment of the disclosure, the scrubbing liquid is generated from a mixture of cation hydroxide, wherein the cation is as disclosed herein, and hydrochloric acid. In one embodiment of the disclosure, the cation hydroxide and the hydrochloric acid is mixed in substantially equimolar ratio.

In one embodiment of the present disclosure, such composition is an aqueous solution of a chloride salt. In one embodiment, such composition comprises from 1 g/L chloride ions to saturation in chloride.

In on embodiment of the present disclosure, such composition is an aqueous solution of a chloride salt, such as an alkali chloride salt. In one embodiment, such composition is an aqueous sodium brine (NaCl) composition. In one embodiment, the scrubbing liquid comprises between 1 and 300 g/L NaCl, such as between 50 and 250, such as between 180 and 220, such as between 200 and 300 g/L NaCl. In one embodiment, such composition has a NaCl concentration between 0.1 g/L and saturation. In one embodiment, such composition is an aqueous potassium chloride composition. In one embodiment, the scrubbing liquid comprises between 1 and 300 g/L KCl, such as between 50 and 250, such as between 180 and 220, such as between 200 and 300 g/L KCl. In one embodiment, such composition has a KCl concentration between 0.1 g/L and saturation. In one embodiment, such composition is an aqueous lithium chloride composition. In one embodiment, the scrubbing liquid comprises between 1 and 300 g/L LiCl, such as between 50 and 250, such as between 180 and 220, such as between 200 and 300 g/L LiCl. In one embodiment, such composition has a LiCl concentration between 0.1 g/L and saturation. In one embodiment, such composition is an aqueous earth alkali chloride composition. In one embodiment, the scrubbing liquid comprises between 1 and 300 g/L earth alkali chloride, such as between 50 and 250, such as between 180 and 220, such as between 200 and 300 g/L earth alkali chloride. In one embodiment, such composition has an earth alkali chloride concentration between 0.1 g/L and saturation. In one embodiment, the scrubbing liquid comprises between 1 and 300 g/L chloride salt, such as between 50 and 250, such as between 180 and 220, such as between 200 and 300 g/L chloride salt. In one embodiment, such composition has a chloride salt concentration between 0.1 g/L and saturation.

One embodiment of the present disclosure provides for a scrubbing liquid generated in the anolyte compartment of the electrolysis element. Such scrubbing liquid is also termed “anolyte” herein. In one embodiment, the anolyte comprises one or more of the species selected from the group consisting of: chlorine, hypochlorite ions, chloride ions, and sodium ions. In one embodiment of the disclosure, the anolyte comprises chlorine, hypochlorite ions, chloride ions, and sodium ions.

One embodiment of the present disclosure provides for a scrubbing liquid generated in the catholyte compartment of the electrolysis element. Such scrubbing liquid is also termed “catholyte” here. In one embodiment, the catholyte comprises one or more of the species elected from the group consisting of: hydroxide ions, chloride ions, and sodium ions. In one embodiment, the catholyte comprises hydroxide ions, chloride ions, and sodium ions.

One embodiment provides for a scrubbing liquid generate in both the anolyte compartment and the catholyte compartment of the electrolysis element. Such scrubbing liquid comprises both anolyte and catholyte.

In one embodiment of the present disclosure, the anolyte and catholyte are mixed within the wet scrubbing element. In one embodiment of the present disclosure, the anolyte and catholyte are not mixed within the one or more wet scrubbing elements. In one embodiment, the spent anolyte and spent catholyte are drained separately from the one or more wet scrubbing and subsequently kept separate.

### Low Liquid Consumption

The present disclosure provides a system for desulfurisation of gases. The system of the disclosure uses a relatively low amount of solvent, such as water, because the scrubbing liquid is continuously recycled. Specifically, after being drained from the wet scrubbing element(s), the scrubbing liquid is electrochemically regenerated in the electrolysis element, after which is may be reapplied to the wet scrubbing elements.

The recycling of the wet scrubbing liquid is also facilitated by the choice of scrubbing liquid. Specifically, if the anolyte and catholyte are generated from an aqueous solution of chloride ions, the scrubbing of H₂S by generated chlorine/hypochlorite will produce chloride ions, which can be converted to chlorine/hypochlorite. Regarding the catholyte, hydroxide ions react with chlorine in the gas to generate hypochlorite, which in turn are converted to chloride ions upon reaction with H₂S. This allows for only an initial amount of aqueous solution of chloride ions (e.g. NaCl) in a finite volume to be supplied to the system, after which the system can carry out desulfurisation for extended periods of time. This effects that a large volume of gas can be desulfurised with a relatively small liquid and chemical volume. This provides a clear advantage over other desulfurisation plants, which may not recycle the scrubbing liquids, and/or which may be dependent on refilling with desulfurisation and/or dechlorination agents.

### Bypass

The system of the present disclosure may comprise one or more bypasses of the electrolysis element. By “bypass” is meant that at least part of the spent scrubbing liquid is fed directly back to the wet scrubbing element without passing through the electrolysis element. However, this is not to be construed that the spent scrubbing liquid does not pass through other elements of the system, such as a filter or a pump, before being fed back to the wet scrubbing element. In one embodiment of the disclosure, the bypass comprises or consists of a liquid transferring element, such as a tube, a pipe, or a channel. In one embodiment electrolysis element bypass is configured to transfer liquid from the scrubbing liquid outlets to the anolyte inlet and/or the catholyte inlet by bypassing the electrolysis element.

As shown in the examples herein, the present inventors found that the efficiency of the generation of oxidising agent improves when part of the spent scrubbing liquid bypasses the electrolysis element. Thus, a bypass of the electrolysis element effects that a relatively small electrolysis element can be employed to regenerate the scrubbing liquid for even high-capacity gas scrubbing systems. Therefore, smaller electrolysis elements can be employed for even large-scale systems to desulfurize gas, saving on both the manufacture costs and the running costs of the system. Regeneration of the scrubbing liquid generally requires more energy, the higher flow is through the electrolysis element. Accordingly, the presence of the bypass allows for a lower flow rate of scrubbing liquid through the electrolysis element, while allowing for a high flow rate of scrubbing liquid through the wet scrubbing element. In conventional systems lacking a bypass of the electrolysis element, the flow rate of the gas to be sulfurised is limited by the flow rate of the scrubbing liquid, which in turn is limited by the capacity of the electrolysis device.

Even if a lower efficiency for the generation of oxidising agent is accepted, having a high scrubbing liquid flow through the electrolysis element can unnecessarily stress and deteriorate the electrolysis element. Thus, it is contemplated that the presence of the bypass increases the lifetime and reduces the need for maintenance of the electrolysis element.

In one embodiment of the present disclosure, 0.1 to 99.9% of the spent scrubbing liquid is fed to the electrolysis element, whereas the remaining spent scrubbing liquid bypasses the electrolysis element. In a further embodiment, 0.1 to 75.0%, such as 0.1 to 50.0%, such as 0.1 to 25.0%, such as 0.1 to 10.0% of the spent scrubbing liquid is fed to the electrolysis element, whereas the remaining scrubbing liquid bypasses the electrolysis element. In one embodiment, 0.1 to 0.3%, such as 0.3 to 0.5%, such as 0.5 to 0.7%, such as 0.7 to 0.9%, such as 0.9 to 1.1%, such as 1.1 to 1.3%, such as 1.3 to 1.5%, such as 1.5 to 2.0%, such as 2.0 to 2.5%, such as 2.5 to 3.0%, such as 3.0 to 4.0%, such as 4.0 to 5.0%, such as 5.0 to 7.0%, such as 7.0 to 10.0% of the spent scrubbing liquid is fed to the electrolysis element, whereas the remaining scrubbing liquid bypasses the electrolysis element. In one embodiment of the present disclosure, about 1% of the spent scrubbing liquid is fed to the electrolysis element, whereas the remaining scrubbing liquid bypasses the electrolysis element. Bypassing the electrolysis element as described above allows for the use of a relatively small electrolysis element to produce and/or regenerate the oxidising agent for even large-scale desulfurisation of gas.

The bypass of the electrolysis element can be achieved in a number of ways. In one embodiment, the system of the disclosure comprises a bypass from the scrubbing liquid outlet of a wet scrubbing element to the anolyte inlet of the same or a different wet scrubbing element. In one embodiment, the system of the disclosure comprises a bypass from the scrubbing liquid outlet of a wet scrubbing element to the catholyte inlet of the same or a different wet scrubbing element. In one embodiment, the system comprises a bypass from the scrubbing liquid outlet of a first wet scrubbing element to the anolyte inlet of said first wet scrubbing element. In one embodiment, the system comprises a bypass from the scrubbing liquid outlet of a second wet scrubbing element to the catholyte inlet of said second wet scrubbing element. In one embodiment, the system comprises a bypass from the scrubbing liquid outlet of a first wet scrubbing element to the catholyte inlet of a second wet scrubbing element. In one embodiment, the system comprises a bypass from the scrubbing liquid outlet of a second wet scrubbing element to the anolyte inlet of a first wet scrubbing element. In one embodiment, the system comprises at least one bypass per scrubber. In one embodiment, the system comprises a bypass from the scrubbing liquid outlet of a first wet scrubbing element to the anolyte inlet of said first wet scrubbing element, and another bypass from the scrubbing liquid outlet of a second wet scrubbing element to the catholyte inlet of said second wet scrubbing element.

In one embodiment of the present disclosure, at least one other element is present between the scrubbing liquid outlet of the wet scrubbing element and the bypass such as one or more elements for splitting the liquid flow, one or more flow control valves, one or more pumps, and/or one or more filters.

In one embodiment of the present disclosure, the bypass is a tube or a hose. In one embodiment, the bypass may comprise one or more flow control valves, one or more pumps, and/or one or more filters.

In one embodiment of the present disclosure, the system further comprises a mixing element. The role of the mixing element is the combine and/or mix two different liquid flows. The two different liquid flows may for example be a liquid flow from the electrolysis element comprising regenerated oxidising agent and a liquid flow from the bypass comprising spent scrubbing liquid. In one embodiment, the mixing element is positioned prior to the anolyte inlet or the catholyte inlet on a wet scrubbing element

### Cleaning of Gasses

The present disclosure provides for a system for cleaning of gas. In one embodiment, said cleaning is desulfurisation. As used herein “cleaning of gas” is the reduction in content of a contaminant such as a sulfur compound.

The system of the present disclosure achieves desulfurisation of gas by wet scrubbing with an oxidising agent. As disclosed herein, the oxidising agent may be chlorine-based, such as chlorine (Cl₂) and/or hypochlorite. It is an issue that desulfurisation using chlorine-based oxidants can introduce chlorine to the gas. It is detrimental having gasses such as fuel gasses contaminated with chlorine, as said chlorine can be incorporated in combustion products. Introduction of chlorine may for example occur when the content of H₂S in the inlet gas decreases, whereby the excess desulfurisation agent (Cl₂) will enter the gas from the scrubbing liquid. On the other hand, should the content of H₂S in the gas suddenly increase, the capacity of the desulfurisation plant may not be sufficient to effective desulfurise said gas. These aspects typically provides desulfurisation plants which are very sensitive to the amount of H₂S in the inlet gas, and as a result, parameters such as H₂S concentration and pH must continuously be monitored and operation parameters adjusted in response to obtain sufficiently desulfurised gas and to avoid introduction of chlorine. Furthermore, chlorine that has been introduced to the gas must be removed, which may require large volumes of additional scrubbing liquid. These aspects can dissuade the industry from using chlorine-based oxidants.

In one embodiment, the disclosed system is configured to desulfurise gas. In one embodiment, the system of the disclosure is configured to full or partial removal of one or more sulfur compounds from the gas.

As outlined herein, the system of the disclosure carries out desulfurisation by a first wet scrubbing of the gas to remove sulfur compounds (upstream in gas flow), and a second wet scrubbing to remove chlorine (downstream in gas flow).

The system of the present disclosure is especially efficient for obtaining effective desulfurisation of gas while ensuring little to no chlorine content to the desulfurised gas. As outlined herein, the system of the disclosure is also robust, requiring little to no adjustment of operating parameters in response to varying H₂S content in the inlet gas. This robustness is achieved by using a first and a second scrubbing liquid, both of which are recycled, and regenerated electrochemically in the system of the disclosure.

Specifically, it is an advantage that the system of the disclosure can be run with a constant current applied to the electrolysis element. This current can be estimated based on an approximation of the H₂S content of the gas in combination with the gas flow. In one embodiment of the present disclosure, the system carries out a first scrubbing of the gas to remove substantially all H₂S. This is achieved by wet scrubbing with a scrubbing liquid comprising a chlorine-based oxidising agent. In one embodiment, this scrubbing liquid is the anolyte as disclosed herein. In a further embodiment, the gas undergoes a second scrubbing (which may occur downstream in the same wet scrubbing element or may occur downstream in a second wet scrubbing element) with a scrubbing liquid capable of removing any chlorine that may have been introduced to the gas during the first scrubbing. In one embodiment, said scrubbing liquid is the catholyte as disclosed herein. As disclosed in the examples below, hydroxide ions are particularly efficient in facilitating removal of chlorine from gasses. As disclosed herein, the anolyte and the catholyte may be produced in parallel by the same electrolysis element, thus supplying both the first scrubbing liquid and the second scrubbing liquid by regenerating spent scrubbing liquid. This eliminates the need for supplying any other agents or reagents to the system during its operation.

The system of the present disclosure is robust to both an increase or a decrease in H₂S content of the inlet gas for the following reasons: i) Assuming the content of H₂S in the inlet gas suddenly decreases and/or that the content of H₂S in the inlet gas is below what was initially estimated, the electrolysis element of the system of the disclosure produces and excess oxidising agent, which may be introduced to the gas during desulfurisation. However, the downstream introduction of the second scrubbing liquid (i.e. catholyte) effectively removes any chlorine that was introduced, as evidenced by the examples herein below. ii) Assuming the content of H₂S in the inlet gas suddenly increases and/or that the content of H₂S in the inlet gas is above what was initially estimated, the electrolysis element may not produce enough oxidising agent (chlorine/hypochlorite) to completely desulfurise the inlet gas during the first scrubbing. However, as the gas passes through the second scrubbing, chlorine previously extracted in the secondary scrubber (and which may be continuously recycled through the second scrubber due to the bypass disclosed herein) acts to remove any H₂S not removed during the first scrubber. In essence, the second scrubber acts as a buffer, extracting chlorine during periods where the electrolysis device produces and excess of oxidising agent, and removing H₂S during periods where the electrolysis device produces a deficit of oxidising agent.

In one embodiment of the disclosure, the gas comprises between 1 and 100000 ppm H₂S prior to being desulfurised. In one embodiment of the disclosure, the gas comprises between 1 and 10000 ppm H₂S prior to being desulfurised. In one embodiment, the gas comprises between 1 and 1000 ppm H₂S prior to being desulfurised. In one embodiment, the gas comprises 1 to 2 ppm H₂S, 2 to 3 ppm H₂S, 3 to 5 ppm H₂S, 5 to 10 ppm H₂S, 10 to 20 ppm H₂S, 20 to 50 ppm H₂S, 50 to 100 ppm H₂S, 100 to 200 ppm H₂S, 200 to 500 ppm H₂S, 500 to 1000 ppm H₂S, 1000 to 2000 ppm H₂S, 2000 to 5000 ppm H₂S, or 5000 to 10000 ppm H₂S prior to being desulfurised.

In one embodiment of the disclosure, desulfurisation comprises removing at least 10%, such as at least 20%, such as at least 30%, such as at least 40%, such as at least 50%, such as at least 60%, such as at least 70%, such as at least 80%, such as at least 90%, such as at least 95%, such as at least 96%, such as at least 97%, such as at least 98%, such as at least 99% of the initial sulfur content of the gas. In one embodiment of the disclosure, desulfurisation comprises removing at least 10%, such as at least 20%, such as at least 30%, such as at least 40%, such as at least 50%, such as at least 60%, such as at least 70%, such as at least 80%, such as at least 90%, such as at least 95%, such as at least 96%, such as at least 97%, such as at least 98%, such as at least 99% of the initial H₂S content of the gas. In one embodiment of the disclosure, desulfurisation comprises removing H₂S from the gas such that the gas comprises at most 100 ppm H₂S, such as at most 90 ppm H₂S, such as at most 80 ppm H₂S, such as at most 70 ppm H₂S, such as at most 60 ppm H₂S, such as at most 50 ppm H₂S, such as at most 40 ppm H₂S, such as at most 30 ppm H₂S, such as at most 20 ppm H₂S, such as at most 15 ppm H₂S, such as at most 10 ppm H₂S, such as at most 5 ppm H₂S, such as at most 4 ppm H₂S, such as at most 3 ppm H₂S, such as at most 2 ppm H₂S, such as at most 1 ppm H₂S.

In one embodiment of the disclosure, the desulfurisation as disclosed herein is achieved while introducing to said gas at most 100 ppm Cl₂, such as at most 90 ppm Cl₂, such as at most 80 ppm Cl₂, such as at most 70 ppm Cl₂, such as at most 60 ppm Cl₂, such as at most 50 ppm Cl₂, such as at most 40 ppm Cl₂, such as at most 30 ppm Cl₂, such as at most 20 ppm Cl₂, such as at most 10 ppm Cl₂, such as at most 5 ppm Cl₂, such as at most 4 ppm Cl₂, such as at most 3 ppm Cl₂, such as at most 2 ppm Cl₂, such as at most 1 ppm Cl₂, such as essentially no Cl₂.

On embodiment of the disclosure provides for a gas desulfurised using the method disclosed herein.

One embodiment of the present disclosure provides for a desulfurised gas as disclosed here comprising:
i. less than 100 ppm H₂S, such as less than 75 ppm H₂S, such as less than 50 ppm H₂S, such as less than 25 ppm H₂S, such as less than 20 ppm H₂S, such as less than 15 ppm H₂S, such as less than 10 ppm H₂S, such as less than 5 ppm H₂S, and
ii. less than 100 ppm C₂, such as less than 75 ppm C₂, such as less than 50 ppm C₂, such as less than 25 ppm C₂, such as less than 20 ppm CO₂, such as less than 15 ppm C₂, such as less than 10 ppm C₂, such as less than 5 ppm C₂.

### Operation Parameters

It is contemplated that the system disclosed herein is capable of being scaled to accept a wide range of gas flows and/or gas flows having a wide range of H₂S of content.

The presently disclosed system is capable of accepting a wide range of gas flows while efficiently desulfurising said gas. In one embodiment, the gas flow rate is between 150 and 400000 Nm³/h. In one embodiment, the gas flow rate is up to 150 Nm³/h. In one embodiment, the gas flow rate is 1 to 2 Nm³/h, 2 to 3 Nm³/h, 3 to 5 Nm³/h, 5 to 7 Nm³/h, 7 to 10 Nm³/h, 10 to 15 Nm³/h, 15 to 20 Nm³/h, 20 to 30 Nm³/h, 30 to 40 Nm³/h, 40 to 50 Nm³/h, 50 to 70 Nm³/h, 70 to 100 Nm³/h, 100 to 150 Nm³/h, 150 to 250 Nm³/h, 250 to 500 Nm³/h, 500 to 1000 Nm³/h, 1000 to 2000 Nm³/h, 2000 to 5000 Nm³/h, 5000 to 10000 Nm³/h, 10000 to 20000 Nm³/h, 20000 to 50000 Nm³/h, 50000 to 100000 Nm³/h, 100000 to 200000 Nm³/h, 200000 to 500000 Nm³/h, 500000 to 1000000 Nm³/h, 1000000 to 2000000 Nm³/h, 2000000 to 3000000 Nm³/h, 3000000 to 4000000 Nm³/h, and/or 4000000 to 5000000 Nm³/h. In one embodiment the gas flow rate is 50 to 500 Nm³/h, such as 80 to 400 Nm³/h, such as 100 to 300 Nm³/h, such as about 150 Nm³/h. Plants such as biogas plants may requirement desulfurisation of a gas flow of about 150 Nm³/h. In one embodiment, the gas flow rate is 50000 to 1000000 Nm³/h, such a 100000 to 800000 Nm³/h, such as 200000 to 600000 Nm³/h, such as about 400000 Nm³/h. Plants such as steel plants may requirement desulfurisation of a gas flow of about 400000 Nm³/h.

The operation parameters of the presently disclosed system can be configured based on knowledge of the approximate pollutant (e.g. H₂S) content of the gas and the flow rate of the gas to be desulfurised. Table 1 outlines the approximate current to apply to the electrolysis element in order to desulfurise gas having the specific content of pollutant and/or H₂S concentration. The information is based on an efficiency of the electrolysis element of 25%. The current can be further modified if the electrolysis element performs with an efficiency different from 25%, i.e. to adjust the current upwards if the electrolysis element performs with an efficiency lower than 25%, or to adjust the current downwards if the electrolysis element performs with an efficiency higher than 25%.

TABLE 1
Current required for different gas flow and pollutant concentration.
The data shown in the table corresponds to a current of about 0.0096
A per ppm H₂S per Nm³/h gas.

| H₂S | | | | | | | | | | |
|---|---|---|---|---|---|---|---|---|---|---|
| concen- | | | | | | | | | | |
| tration | Gas flow Nm³/h | | | | | | | | | |
| ppm | 100 | | 1,000 | | 10,000 | | 100,000 | | 1,000,000 | |
| 1 | 1 | A | 10 | A | 96 | A | 960 | A | 9.6 | kA |
| 10 | 10 | A | 96 | A | 960 | A | 9.6 | kA | 96 | kA |
| 100 | 96 | A | 960 | A | 9.6 | kA | 96 | kA | 960 | kA |
| 1,000 | 960 | A | 9.6 | kA | 96 | kA | 960 | kA | 9.6 | MA |
| 10,000 | 9.6 | kA | 96 | kA | 960 | kA | 9.6 | MA | 96 | MA |

In on embodiment, current applied to the system is 0.0040 to 0.0200 A per ppm H₂S per Nm³/h gas. In one embodiment, the current applied to the system is 0.0040 to 0.0045 A per ppm H₂S per Nm³/h gas, such as 0.0045 to 0.0050 A per ppm H₂S per Nm³/h gas, such as 0.0050 to 0.0055 A per ppm H₂S per Nm³/h gas, such as 0.0055 to 0.0060 A per ppm H₂S per Nm³/h gas, such as 0.0060 to 0.0065 A per ppm H₂S per Nm³/h gas, such as 0.0065 to 0.0070 A per ppm H₂S per Nm³/h gas, such as 0.0070 to 0.0075 A per ppm H₂S per Nm³/h gas, such as 0.0075 to 0.0080 A per ppm H₂S per Nm³/h gas, such as 0.0080 to 0.0085 A per ppm H₂S per Nm³/h gas, such as 0.0085 to 0.0090 A per ppm H₂S per Nm³/h gas, such as 0.0090 to 0.0095 A per ppm H₂S per Nm³/h gas, such as 0.0095 to 0.0100 A per ppm H₂S per Nm³/h gas, such as 0.0100 to 0.0110 A per ppm H₂S per Nm³/h gas, such as 0.0110 to 0.0120 A per ppm H₂S per Nm³/h gas, such as 0.0120 to 0.0130 A per ppm H₂S per Nm³/h gas, such as 0.0130 to 0.0140 A per ppm H₂S per Nm³/h gas, such as 0.0140 to 0.0150 A per ppm H₂S per Nm³/h gas, such as 0.0150 to 0.0160 A per ppm H₂S per Nm³/h gas, such as 0.0160 to 0.0170 A per ppm H₂S per Nm³/h gas, such as 0.0170 to 0.0180 A per ppm H₂S per Nm³/h gas, such as 0.0180 to 0.0190 A per ppm H₂S per Nm³/h gas, such as 0.0190 to 0.0200 A per ppm H₂S per Nm³/h gas.

The amount of current required to desulfurise the gas can alternatively be expressed in amperes per g sulfur to desulfurise per hour. By “g sulfur per hour” is meant the amount of sulfur expressed g that is fed via the gas to the system per hour. Such sulfur may exist as H₂S in the gas. In one embodiment, the current is 4.0 to 9.0 A per g sulfur per hour. In one embodiment, the current is 4.0 to 4.2 A per g sulfur per hour, 4.2 to 4.4 A per g sulfur per hour, 4.4 to 4.6 A per g sulfur per hour, 4.6 to 4.8 A per g sulfur per hour, 4.8. to 5.0 A per g sulfur per hour, 5.0 to 5.2 A per g sulfur per hour, 5.2 to 5.4 A per g sulfur per hour, 5.4 to 5.6 A per g sulfur per hour, 5.6 to 5.8 A per g sulfur per hour, 5.8 to 6.0 A per g sulfur per hour, 6.0 to 6.2 A per g sulfur per hour, 6.2 to 6.4 A per g sulfur per hour, 6.4 to 6.6 A per g sulfur per hour, 6.6 to 6.8 A per g sulfur per hour, 6.8 to 7.0 A per g sulfur per hour, 7.0 to 7.2 A per g sulfur per hour, 7.2 to 7.4 A per g sulfur per hour, 7.4 to 7.6 A per g sulfur per hour, 7.6 to 7.8 A per g sulfur per hour, 7.8 to 8.0 A per g sulfur per hour, 8.0 to 8.2 A per g sulfur per hour, 8.2 to 8.4 A per g sulfur per hour, 8.4 to 8.6 A per g sulfur per hour, 8.6 to 8.8 A per g sulfur per hour, and/or 8.8 to 9.0 A per g sulfur per hour. In one embodiment, the current is 5.0 to 7.4 A per g sulfur per hour, such as 5.2 to 7.2 A per g sulfur per hour, such as 5.4 to 7.0 A per g sulfur per hour, such as 5.6 to 6.8 A per g sulfur per hour, such as 5.8 to 6.6 A per g sulfur per hour, such as 6.0 to 6.4 A per g sulfur per hour, such as about 6.2 A per g sulfur per hour. The current can be further modified if the electrolysis element performs with an efficiency different from 25%, i.e. to adjust the current upwards if the electrolysis element performs with an efficiency lower than 25%, or to adjust the current downwards if the electrolysis element performs with an efficiency higher than 25%. In one embodiment, such modification is inversely proportional to the performance of the electrolysis element.

The system of the present disclosure can be configured to run at different liquid flow rates, i.e. the liquid flow rates through the one or more scrubber elements. In one embodiment, the liquid flow rate is 10 kg/h to 3000000 ton/h. In one embodiment the liquid flow rate is up to 10 kg/h, 10 to 15 kg/h, 15 to 20 kg/h, 20 to 30 kg/h, 30 to 40 kg/h, 40 to 50 kg/h, 50 to 70 kg/h, 70 to 100 kg/h, 100 to 150 kg/h, 150 to 250 kg/h, 250 to 500 kg/h, 500 to 1000 kg/h, 1000 to 2000 kg/h, 2000 to 3000 kg/h, 3000 to 5000 kg/h, 5000 kg/h to 10 ton/h, 10 to 15 ton/h, 15 to 20 ton/h, 20 to 30 ton/h, 30 to 40 ton/h, 40 to 50 ton/h, 50 to 70 ton/h, 70 to 100 ton/h, 100 to 150 ton/h, 150 to 250 ton/h, 250 to 500 ton/h, 500 to 1000 ton/h, 1000 to 1500 ton/h, 1500 to 2000 ton/h, 2000 to 3000 ton/h, 3000 to 5000 ton/h, 5000 to 70000 ton/h, 70000 to 100000 ton/h, 100000 to 150000 ton/h, 150000 to 250000 ton/h, 250000 to 500000 ton/h, 500000 to 1000000 ton/h, 1000000 to 2000000 ton/h, and/or 2000000 to 3000000 ton/h. In one embodiment, the liquid flow rate is 15 to 50 ton/h. Plants such as biofuel plants may use a liquid flow rate of 15 to 50 ton/h. In one embodiment, the liquid flow rate is 40000 to 100000 ton/h. Plants such as steel plants may use a liquid flow rate of 40000 to 100000 ton/h. As used herein, for a liquid having a density of about 1 kg/L, a flow rate given in ton/h corresponds approximately to a flow rate given in Nm³/h. For liquids having densities significantly different from 1 kg/L, it is necessarily to account for the density when converting between ton/g and Nm³/h. In one embodiment, the liquid flow rate (in Nm³/h) corresponds to between 5% and 50% of the gas flow rate (in Nm³/h). In one embodiment, the liquid flow rate (in Nm³/h) corresponds to 5 to 10%, 10 to 15%, 15 to 20%, 20% to 25%, 25 to 30%, 30 to 35%, 35 to 40%, 40 to 45%, and/or 45 to 50% of the gas flow rate (in Nm³/h). By way of example, for an embodiment of the system using a 100 Nm³/h gas flow and a 10 Nm³/h liquid flow, the liquid flow corresponds to 10% of the gas flow.

### System of the Disclosure

One embodiment of the present disclosure provides for a system for cleaning of gas, said system comprising:
i. an electrolysis element comprising separate anolyte- and catholyte compartments for generation of an anolyte and a catholyte, respectively, and
ii. a wet scrubbing element comprising:
   a gas inlet and a gas outlet defining the direction of the gas flow;
an anolyte inlet and a catholyte inlet, wherein the catholyte inlet is separate and downstream from the anolyte inlet relative to the direction of the gas flow; and
   one or more scrubbing liquid outlets
      said one or more scrubbing liquid outlets at least in part supplying the electrolysis element.

In one embodiment of the disclosure, the anolyte compartment and the catholyte compartment supply the wet scrubbing element, said catholyte being introduced to the wet scrubbing element at a catholyte inlet which is separate and downstream from an anolyte inlet, relative to the direction of the gas flow through the one or more wet scrubbing elements, and wherein the one or more wet scrubbing elements comprise one or more scrubbing liquid outlets, said one or more scrubbing liquid outlets at least in part supplying the electrolysis element.

In one embodiment of the disclosure, the system comprises:
i. a liquid transferring element from the anolyte compartment to the anolyte inlet,
ii. a liquid transferring element from the catholyte compartment to the catholyte inlet, and/or
iii. one liquid transferring element from each of the one or more scrubbing liquid outlets to the electrolysis element.

In one embodiment, the system comprises:
i. a liquid transferring element from the anolyte compartment to the anolyte inlet,
ii. a liquid transferring element from the catholyte compartment to the catholyte inlet, and
iii. one or more liquid transferring elements from the one or more scrubbing liquid outlets to the electrolysis element.

Such liquid transferring elements function to transfer liquid between the specified parts of the system. The liquid transferring elements may for example be pipes, tubes, and/or channels. The liquid transferring elements can be of any length sufficient for connecting the specified parts.

In one embodiment, the system of the disclosure comprises an electrolysis element bypass between the one or more scrubbing liquid outlets and the anolyte inlet and/or catholyte inlet. In one embodiment one or more scrubbing liquid outlets at least in part bypasses the electrolysis element to supply the wet scrubbing elements. In one embodiment, the bypass is a liquid transferring element.

In one embodiment, the system of the disclosure comprises two wet scrubbing elements connected in series with respect to the gas flow.

If the system of the disclosure comprises two or more wet scrubbing elements, the wet scrubbing element that the gas passes through first is designated the first wet scrubbing element, the element that the gas passes through second is designated the second wet scrubbing element (etc.).

In one embodiment, the gas is a fuel gas. In a further embodiment, the fuel gas is selected from the group consisting of coke-oven gas, natural gas, gas from geothermal plants, shale gas, and landfill gas.

In one embodiment, the gas is selected from the group consisting of process gas from the production of bio-technical products, e.g. pharma products, and exhaust gas from chemical factories, e.g. paint factories.

In one embodiment of the present disclosure, the electrolysis element comprises a single liquid inlet supplying both the anolyte compartment and the catholyte compartment. In one embodiment, the electrolysis element comprises a single liquid inlet configured to supply both the anolyte compartment and the catholyte compartment.

In one embodiment, the electrolysis element comprises one liquid inlet supplying the anolyte compartment and another liquid inlet supplying the catholyte compartment.

In one embodiment of the present disclosure, the one or more wet scrubbing elements are one or more wet scrubbing towers.

In one embodiment of the present disclosure, the system comprises a wet scrubbing element having a scrubbing liquid outlet, wherein said scrubbing liquid outlet is positioned between the anolyte inlet and the catholyte inlet.

In one embodiment, the scrubbing liquid outlet supply the wet scrubbing element at the anolyte inlet. In one embodiment, the scrubbing liquid outlet is configured to supply the wet scrubbing element at the anolyte inlet.

In one embodiment of the present disclosure, the scrubbing liquid outlet supply the wet scrubbing element at the catholyte inlet. In one embodiment, the scrubbing liquid outlet is configured to supply the wet scrubbing element at the catholyte inlet.

In one embodiment of the present disclosure, the scrubbing liquid outlet supply both the electrolysis element and the wet scrubbing element at the anolyte inlet. In one embodiment, the scrubbing liquid outlet is configured to supply both the electrolysis element and the wet scrubbing element at the anolyte inlet.

In one embodiment of the present disclosure, the scrubbing liquid outlet supply both the electrolysis element and the wet scrubbing element at the catholyte inlet. In one embodiment, the scrubbing liquid outlet is configured to supply both the electrolysis element and the wet scrubbing element at the catholyte inlet.

In one embodiment, part of the catholyte, but not all of the catholyte, is being introduced to the wet scrubbing element at the anolyte inlet. In one embodiment, the system is configured to introduce part, but not all of the catholyte, to the wet scrubbing element at the anolyte inlet.

One embodiment of the present disclosure provides a system, wherein:
i. the system comprises a first scrubbing element and a second scrubbing element,
ii. the anolyte compartment supplies a first scrubbing element at its anolyte inlet,
iii. the catholyte compartment supplies a second scrubbing element at its catholyte inlet,
iv. the liquid outlet of the first scrubber element supplies the electrolysis element and the anolyte inlet of the first scrubbing element, and
v. the liquid outlet of the second scrubbing element supplies the electrolysis element and the catholyte inlet of the second scrubbing element.

One embodiment of the present disclosure provides a system wherein:
i. the system comprises a first wet scrubbing element and a second wet scrubbing element,
ii. the anolyte compartment is configured to supply a first wet scrubbing element at its anolyte inlet,
iii. the catholyte compartment is configured to supply a second wet scrubbing element at its catholyte inlet,
iv. the liquid outlet of the first wet scrubbing element is configured to supply the electrolysis element and the anolyte inlet of the first wet scrubbing element, and
v. the liquid outlet of the second wet scrubbing element is configured to supply the electrolysis element and the catholyte inlet of the second wet scrubbing element.

In one embodiment of the disclosure, the one or more wet scrubbing elements are two wet scrubbing towers.

In one embodiment of the disclosure, the one or more wet scrubbing elements is a single wet scrubbing tower.

In one embodiment, the system comprises a single wet scrubbing tower, wherein the catholyte inlet is positioned downstream of the anolyte inlet relative to the direction of the gas flow.

In one embodiment, the single scrubbing tower comprises a single scrubbing liquid outlet upstream of the anolyte inlet.

One embodiment provides a system, wherein the single scrubbing tower comprises a scrubbing liquid outlet between the catholyte inlet and the anolyte inlet, and a further scrubbing liquid outlet upstream of the anolyte inlet.

One embodiment of the disclosure provides a system comprising a first scrubbing element and a second scrubbing element, and wherein the direction of the gas flow is from the first scrubbing element to the second scrubbing element.

In one embodiment of the disclosure, the electrolysis element consumes 4.0 to 9.0 A per g sulfur per hour. In one embodiment, the electrolysis element consumes 4.0 to 4.2 A per g sulfur per hour, 4.2 to 4.4 A per g sulfur per hour, 4.4 to 4.6 A per g sulfur per hour, 4.6 to 4.8 A per g sulfur per hour, 4.8. to 5.0 A per g sulfur per hour, 5.0 to 5.2 A per g sulfur per hour, 5.2 to 5.4 A per g sulfur per hour, 5.4 to 5.6 A per g sulfur per hour, 5.6 to 5.8 A per g sulfur per hour, 5.8 to 6.0 A per g sulfur per hour, 6.0 to 6.2 A per g sulfur per hour, 6.2 to 6.4 A per g sulfur per hour, 6.4 to 6.6 A per g sulfur per hour, 6.6 to 6.8 A per g sulfur per hour, 6.8 to 7.0 A per g sulfur per hour, 7.0 to 7.2 A per g sulfur per hour, 7.2 to 7.4 A per g sulfur per hour, 7.4 to 7.6 A per g sulfur per hour, 7.6 to 7.8 A per g sulfur per hour, 7.8 to 8.0 A per g sulfur per hour, 8.0 to 8.2 A per g sulfur per hour, 8.2 to 8.4 A per g sulfur per hour, 8.4 to 8.6 A per g sulfur per hour, 8.6 to 8.8 A per g sulfur per hour, and/or 8.8 to 9.0 A per g sulfur per hour. In one embodiment, the electrolysis element consumes 5.0 to 7.4 A per g sulfur per hour, such as 5.2 to 7.2 A per g sulfur per hour, such as 5.4 to 7.0 A per g sulfur per hour, such as 5.6 to 6.8 A per g sulfur per hour, such as 5.8 to 6.6 A per g sulfur per hour, such as 6.0 to 6.4 A per g sulfur per hour, such as about 6.2 or 6.3 A per g sulfur per hour. In one embodiment, the electrolysis element is configured to consume 4.0 to 9.0 A per g sulfur per hour. In one embodiment, the electrolysis element is configured to consume 4.0 to 4.2 A per g sulfur per hour, 4.2 to 4.4 A per g sulfur per hour, 4.4 to 4.6 A per g sulfur per hour, 4.6 to 4.8 A per g sulfur per hour, 4.8. to 5.0 A per g sulfur per hour, 5.0 to 5.2 A per g sulfur per hour, 5.2 to 5.4 A per g sulfur per hour, 5.4 to 5.6 A per g sulfur per hour, 5.6 to 5.8 A per g sulfur per hour, 5.8 to 6.0 A per g sulfur per hour, 6.0 to 6.2 A per g sulfur per hour, 6.2 to 6.4 A per g sulfur per hour, 6.4 to 6.6 A per g sulfur per hour, 6.6 to 6.8 A per g sulfur per hour, 6.8 to 7.0 A per g sulfur per hour, 7.0 to 7.2 A per g sulfur per hour, 7.2 to 7.4 A per g sulfur per hour, 7.4 to 7.6 A per g sulfur per hour, 7.6 to 7.8 A per g sulfur per hour, 7.8 to 8.0 A per g sulfur per hour, 8.0 to 8.2 A per g sulfur per hour, 8.2 to 8.4 A per g sulfur per hour, 8.4 to 8.6 A per g sulfur per hour, 8.6 to 8.8 A per g sulfur per hour, and/or 8.8 to 9.0 A per g sulfur per hour. In one embodiment, the electrolysis element is configured to consume 5.0 to 7.4 A per g sulfur per hour, such as 5.2 to 7.2 A per g sulfur per hour, such as 5.4 to 7.0 A per g sulfur per hour, such as 5.6 to 6.8 A per g sulfur per hour, such as 5.8 to 6.6 A per g sulfur per hour, such as 6.0 to 6.4 A per g sulfur per hour, such as about 6.2 or 6.3 A per g sulfur per hour. The consumption is based on an electrolysis element having an efficiency of about 25%. The amount of current consumed can be further affected if the electrolysis element performs with an efficiency different from 25%, i.e. the current upwards can be adjusted upwards if the electrolysis element performs with an efficiency lower than 25%, or the current can be adjusted downwards if the electrolysis element performs with an efficiency higher than 25%. In one embodiment, such modification is inversely proportional to the performance of the electrolysis element.

In one embodiment of the disclosure, the electrolysis element is an electrochemical cell.

In one embodiment of the disclosure, the system comprises one or more filters. In one embodiment, the filter is positioned after the liquid outlet to a wet scrubbing element, such as after the wet scrubbing element to which the anolyte is supplied. In one embodiment of the disclosure, the filter is positioned at or after the liquid outlet of the one or more wet scrubbing elements.

In one embodiment of the disclosure, the system comprises one or more pumps, such as:
i. a pump prior to the electrolysis element, such as a liquid pump;
ii. a pump after the liquid outlet of one wet scrubbing element, such as a liquid pump;
iii. a pump prior to the anolyte inlet, such as a liquid pump;
iv. a pump prior to the catholyte inlet, such as a liquid pump;
v. a pump prior to the gas inlet on the wet scrubbing element, such as a gas pump;
vi. a pump after the electrolysis element, such as a pump capable of sucking liquid through a system.

In one embodiment, the system comprises a filter. In one embodiment, the filter is capable of separating solids from liquid. In one embodiment, the filter comprises a filter medium through which fluids can pass, but wherein solids are retained. In one embodiment the filter is a membrane filter. In one embodiment, the filter is capable of removing ions, such as specific ions, from the liquid phase. In one embodiment, the filter is an ion chromatograph.

In one embodiment of the disclosure, the system comprises one or more filters, such as
i. a filter prior to the electrolysis element,
ii. a filter after the liquid outlet of one wet scrubbing element,
iii. a filter prior to a pump,
iv. a filter prior to the anolyte inlet,
v. a filter prior to the catholyte inlet, and/or
vi. a filter after the electrolysis element.

In one embodiment of the present disclosure, the system comprises one or more flow control valves. In one embodiment, the flow rate of a liquid or a gas may be controlled by such flow control valve. In one embodiment, the flow rate of a liquid or a gas may be controlled by a pump.

One embodiment of the present disclosure provides for a fuel gas processing plant comprising the system as disclosed herein.

One embodiment of the disclosure provides for a system configured for performing the method as disclosed herein.

### Methods of Desulfurisation

On embodiment provides for a method for desulfurisation of gas, said method comprising the steps of
i. providing an electrolysis element comprising separate compartments for generation of an anolyte and a catholyte,
ii. providing one or more wet scrubbing elements,
iii. providing a scrubbing liquid comprising an alkali chloride,
iv. providing a gas comprising a sulfur compounds,
v. conducting a electrochemical conversion of said scrubbing liquid to produce a anolyte comprising an oxidising agent and a catholyte comprising a base,
vi. conducting a first scrubbing of said gas by contacting said gas with said anolyte in one wet scrubbing element, thereby obtaining a desulfurised gas and a spent scrubbing liquid, and conducting a second scrubbing of said gas by contacting said gas with said catholyte, thereby obtaining a desulfurised and dechlorinated gas and a spent scrubbing liquid, wherein the second scrubbing is conducted downstream of the first scrubbing relative to the direction of the gas flow.
vii. recycling the spent scrubbing liquid by
   a. supplying at least parts of the spent scrubbing liquid to the electrolysis element

In one embodiment, step vii. further comprises a step of:
b. supplying at least parts of the spent scrubbing liquid directly to the wet scrubbing elements by bypassing the electrolysis element.

In one embodiment of the disclosure, the content of H₂S in the gas comprising the sulfur compound is 10 to 20.000, such as 10 to 5000 ppm, such as 100 to 4000 ppm, such as 500 to 2500 ppm. In one embodiment of the disclosure, the content of H₂S in the gas comprising the sulfur compound is 20 to 250 ppm, such as 50 to 250 ppm.

In one embodiment of the disclosure, the content of H₂S in the gas comprising the sulfur compound varies substantially between feedstock compositions and/or other external parameters, such as temperature.

In one embodiment, the variation in H₂S content is of a type such that a method comprising no introduction of catholyte would be insufficient to ensure removal of H₂S without introducing Cl₂ to the gas.

In one embodiment, the variation in H₂S content is of a type such that a method comprising no introduction of catholyte would be insufficient to ensure removal of H₂S without introducing Cl₂ to the gas unless the current applied to the electrolysis element was continuously modified to accommodate the varying content of H₂S.

In one embodiment, the method disclosed herein can tolerate a 100% variation in the content of H₂S in the gas comprising sulfur compounds while still removing substantially all H₂S from the gas and without introducing substantially any C₂ to the gas.

In one embodiment, the method disclosed herein can tolerate a 50% variation in the content of H₂S in the gas comprising sulfur compounds while still removing substantially all H₂S from the gas and without introducing substantially any C₂ to the gas, and without varying the current applied to the electrolysis element.

In one embodiment, no adjustment of the voltage and/or current supplied to electrolysis element is required to accommodate a 100% variation of H₂S content in the gas.

In one embodiment of the disclosure, the alkali chloride is NaCl.

In one embodiment of the disclosure, the scrubbing liquid comprises between 1 and 300 g/L NaCl, such as between 50 and 250, such as between 180 and 220, such as between 200 and 300 g/L.

In one embodiment of the present disclosure, the method does not comprise a step of adding NaOH, NaClO, HClO, or Cl₂ from an external source to the scrubbing liquid. In one embodiment of the present disclosure, the method comprises generation of NaOH, NaClO, HClO, and Cl₂, such as electrochemical generation.

One embodiment of the present disclosure provides for a method of desulfurising gas, said method using the system disclosed herein.

### EXAMPLES

### Example 1: Bypass of Electrochemical Cell Improves Faraday Efficiency

### Materials and Methods

Set-up with bypass: power supply from 0-12 V, 0-60 A, electrochemical cell 10 cm² electrode areas, membrane proton exchange, scrubber Ø110 mm, height 60 cm, full-cone spray nozzle, random packing elements Raschig Pall rings 15 mm×15 mm, 2 pumps 10-50 L/min and 1-5 L/min. A schematic of the setup used is shown in FIG. 1. Set-up without bypass: power supply from 0-48 V, 0-200 A, electrochemical cell without membrane, electrode area: 4200 cm2, scrubber 03150 mm, height 50-80 cm, full-cone spray nozzle, random packing elements Raschig Pall rings 15 mm×15 mm, pump flow 12.5-13 L/min.

The assessment was conducted at using a current of 0-90 A and a voltage of 3-13 V. A total liquid volume of 27 L was circulated in the system having an initial NaCl concentration of 300 g/L for the set-up without the bypass. Without bypass of the electrochemical cell, the first pump, supplying the scrubber directly, was run with a flow rate of 12.5-13 L/min.

The assessment was conducted at using a current of 0-4.5 A and a voltage of 0-12 V. A total liquid volume of 7 L was circulated in the system having an initial NaCl concentration of 50 g/L for the set-up with the bypass

With bypass of the electrochemical cell, the first pump, was run with a flow rate of 5-500 L/min. The second pump, was run with a flow rate of 0.5-1 L/min.

### Results

Running the setup without bypass of the electrochemical provided Faraday efficiency of 6 to 19%. Bypass of the electrochemical cell increased the Faraday efficiency of electrochemical cell to between 23 and 42%. These findings support that the presence of a bypass improves efficiency of the system.

### Conclusion

Separately controlled flow in the electrochemical cell allows for improved Faraday efficiency of the electrochemical cell.

### Example 2: Different Gas Flow

### Materials and Methods

Power supply from 0-12 V, 0-60 A, electrochemical cell 10 cm² electrode areas, membrane proton exchange, 1 scrubber Ø110, height 60 cm, full-cone spray nozzle, random packing elements Raschig Pall rings 15 mm×15 mm, 2 pumps 10-50 L/min and 1-5 L/min.

The assessment was conducted at using a current of 0.5-3.9 A and a voltage of 3.3-8.4 V. A total liquid volume of 7 L was circulated in the system. Inlet concentration of H₂S: 1000 ppm, pump flow 500 L/h, initial NaCl concentration in liquid 50 g/L. The first pump, supplying the scrubber directly, was run with a flow rate of 500 L/h. The second pump, supplying the electrochemical cell was run with a flow rate of 1 L/min. A schematic of the setup used is shown in FIG. 1.

### Results

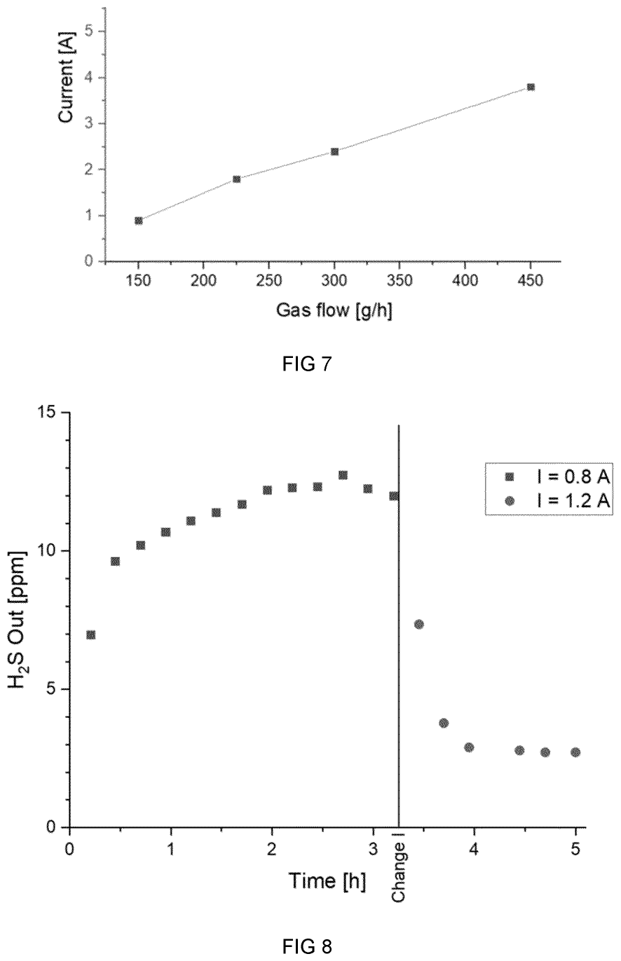

When the gas flow increases a higher amount of current was needed to remove the H₂S. Total gas flows of 150 g/h, 225 g/h, 300 g/h and 450 g/h was tested and removal of >98.6% of the H₂S was achieved for all flows. The current as a function of gas flow is shown in FIG. 7. A near-linear correlation between gas flow and required current was observed. The H₂S removal efficiency was consistently high, as shown in Table 2.

TABLE 2
H₂S removal efficiency as a function of gas flow.

| Gas flow (g/h) | H₂S removal efficiency (%) |
|---|---|
| 150 | 98.6 |
| 225 | 99.5 |
| 300 | 98.7 |
| 450 | 99.2 |

### Conclusion

H₂S was removed at different gas flows. These findings demonstrate that the system of the disclosure provides a robust platform for the removal of H₂S from gas, capable of accepting a wide range of gas flows.

### Example 3: Lower Current Thresholds in Electrochemical Cell for Efficient Removal of H₂S

### Materials and Methods

Power supply from 0-12 V, 0-60 A, electrochemical cell 10 cm² electrode areas, membrane proton exchange, scrubber Ø110, height 60 cm, full-cone spray nozzle, random packing elements Raschig Pall rings 15 mm×15 mm, 2 pumps 10-50 L/min and 1-5 L/min.

The assessment was conducted at using a voltage of 3.5-4.3 V. A total liquid volume of 7 L was circulated in the system. Gas flow 300 g/h, inlet concentration of H₂S: 500 ppm, pump flow 500 L/h, initial NaCl concentration in liquid 50 g/L. The first pump, supplying the scrubber directly, was run with a flow rate of 500 L/h. The second pump, supplying the electrochemical cell was run with a flow rate of 1 L/min. A schematic of the setup used is shown in FIG. 1.

### Results

When a current of 0.8 A was applied to the electrochemical cell, 12.4 ppm H₂S was left in the purified gas, corresponding to removal efficiency of 97.5%. When a current a 1.2 A was applied to the electrochemical cell, 2.8 ppm H₂S was left in the purified gas, corresponding to removal efficiency of 99.4%.

### Conclusion

The system was capable of removing H₂S down to very low concentration, provided a sufficient current is applied. For this specific example, the removal of H₂S improved significantly upon increasing the current from 0.8 to 1.2 A. However, the employed current should not be taken as an absolute threshold, as the current required depends on the size of the electrochemical cell, which in turn depends on the capacity of the system.

### Example 4: Solvent Flow

### Materials and Methods

Power supply from 0-12 V, 0-60 A, electrochemical cell 10 cm² electrode areas, membrane proton exchange, scrubber Ø110, height 60 cm, full-cone spray nozzle, random packing elements Raschig Pall rings 15 mm×15 mm, 2 pumps 10-50 L/min and 1-5 L/min.

Gas flow 450 g/h, inlet concentration of H₂S: 500 ppm, initial NaCl concentration in liquid 50 g/L, current 1.6 A. The first pump, supplying the scrubber directly, was run with a flow rate of 50-500 L/h. The second pump, supplying the electrochemical cell was run with a flow rate of 1 L/min. A total liquid volume of 7 L was circulated in the system. A schematic of the setup used is shown in FIG. 1.

### Results

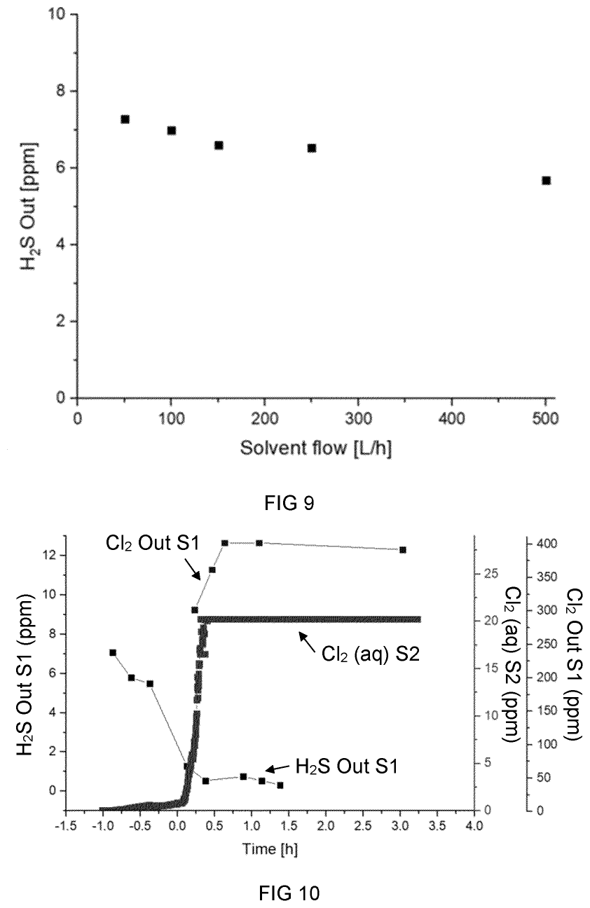

The total solvent flow was tested at 50 L/h, 100 L/h, 150 L/h, 250 L/h and 500 L/h. The H₂S concentration in the cleaned gas was between 5 and 8 ppm for all set points. The H₂S content as a function of the solvent flow is shown in FIG. 9.

### Conclusion

It was found that the system is capable of removing H₂S essentially independent of solvent flow rate. These findings demonstrate that the system of the disclosure provides a robust platform for the removal of H₂S from gas, capable of accepting a wide range of gas flows and providing consistent removal of H₂S.

### Example 5: Upper Current Threshold

### Materials and Methods

Power supply from 0-12 V, 0-60 A, electrochemical cell 10 cm² electrode areas, membrane proton exchange, two scrubbers Ø110, height 60 cm, full-cone spray nozzle, random packing elements Raschig Pall rings 15 mm×15 mm, 2 pumps 10-50 L/min and 1-5 L/min.

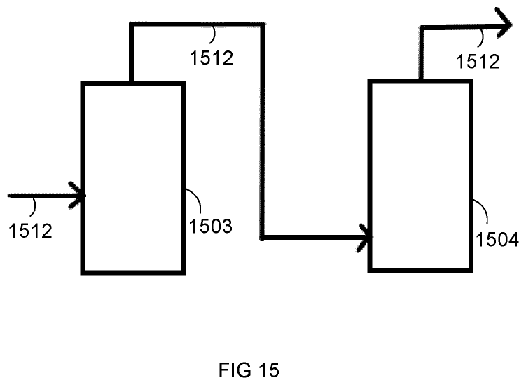

Gas flow 225 g/h, Inlet concentrations of H₂S: 800 and 1000 ppm, initial NaCl concentration in liquid 50 g/L, current 1.8 A. The first pump, supplying the scrubber directly, was run with a flow rate of 500 L/h. The second pump, supplying the electrochemical cell was run with a flow rate of 1 L/min. A total liquid volume of 6.66 L was circulated in the scrubber 1 system. A total liquid volume of 7.2 L was circulated in the scrubber 2 system. A schematic of the setup used is shown in FIG. 15.

### Results

Using a current of 1.8 A, the system removed H₂S from 1000 ppm down to 5-7 ppm, with no chlorine present in the desulfurised gas. When the inlet concentration of H₂S was reduced to 800 ppm, the electrochemical cell was found to produce excess Cl₂ gas relative to the amount of H₂S present in the gas: the content of Cl₂ gas was measured to reach a concentration of 400 ppm in the desulfurized gas. The results are shown in FIG. 10. The read of 20 ppm Cl₂ in the figure was due to the detector being saturated.

### Conclusion

The results above suggest that employing an excessive amount of current relative to the H₂S present in the inlet gas can lead to a build-up of C₂ in the purified gas. However, the employed currents should not be taken as absolute thresholds, as the current needed will depend on the size of the electrochemical cell, which in turn depends on the capacity of the system.

### Example 6: Secondary Scrubber for Cl₂ Removal Using Tap Water

### Materials and Methods

Power supply from 0-12 V, 0-60 A, electrochemical cell 10 cm² electrode areas, membrane proton exchange, 2 scrubbers Ø110, height 60 cm, full-cone spray nozzle, random packing elements Raschig Pall rings 15 mm×15 mm, 3 pumps 10-50 L/min, 10-50 L/min and 1-5 L/min.

Gas flow 225 g/h, inlet concentration of H₂S: 800 ppm, initial NaCl concentration in liquid 50 g/L, current 2 A. The first pump supplying scrubber 1 directly, was run with a flow rate of 500 L/h. The second pump supplying the electrochemical cell was run with a flow rate of 1 L/min. The third pump supplying scrubber 2 was run with a flow rate of 8 L/min. A total liquid volume of 6.66 L was circulated in the scrubber 1 system. A total liquid volume of 7.2 L was circulated in the scrubber 2 system. A schematic of the setup used is shown in FIG. 2.

### Results

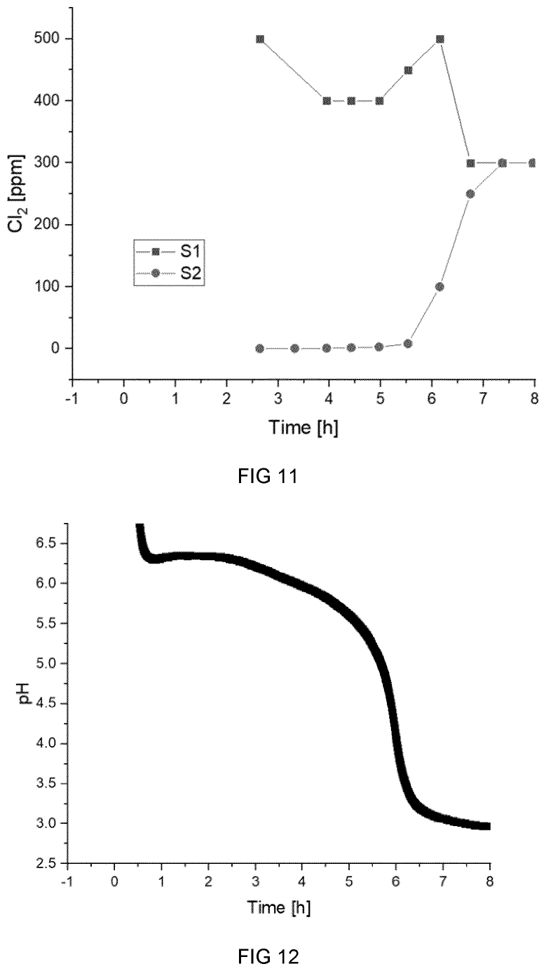

Using a current of 2 A, the system removed 800 ppm H₂S and the electrochemical cell produced excess Cl₂ gas. The Cl₂ gas was measured to reach a concentration of 400 ppm in the desulfurized gas. A secondary scrubber with tap water was used to remove the Cl₂ gas. The content of Cl₂ in the scrubber 1 outlet gas and the scrubber 2 outlet gas is shown in FIG. 11. The pH of the scrubbing liquid of scrubber 2 is shown in FIG. 12. The secondary scrubber could remove the Cl₂ for 6 hours before the solvent in the secondary scrubber system was saturated with Cl₂.

### Conclusion

A high current was applied to the electrochemical cell in order to induce a transfer of chlorine to the desulfurized gas. This chlorine was successfully removed with tap water, but said water had only moderate capacity for chlorine before becoming saturated. These findings indicates another scrubbing liquid should be employed in order to facilitate recycling of the scrubbing liquid.

### Example 7: Secondary Scrubber for Cl₂ Removal Using Tap Water with NaOH

### Materials and Methods

Power supply from 0-12 V, 0-60 A, electrochemical cell 10 cm² electrode areas, membrane proton exchange, 2 scrubbers Ø110 mm, height 60 cm, full-cone spray nozzle, random packing elements Raschig Pall rings 15 mm×15 mm, 3 pumps 10-50 L/min, 10-50 L/min and 1-5 L/min.

Gas flow 225 g/h, inlet concentration of H₂S: 800 ppm, initial NaCl concentration in liquid 50 g/L, current 1.8 A, solvent flow: 500 L/h. The first pump supplying scrubber 1 directly, was run with a flow rate of 500 L/h. The second pump supplying the electrochemical cell was run with a flow rate of 1 L/min. The third pump supplying scrubber 2 was run with a flow rate of 8 L/min. A total liquid volume of 6.66 L was circulated in the scrubber 1 system. A total liquid volume of 7.2 L was circulated in the scrubber 2 system. A schematic of the setup used is shown in FIG. 2.

### Results

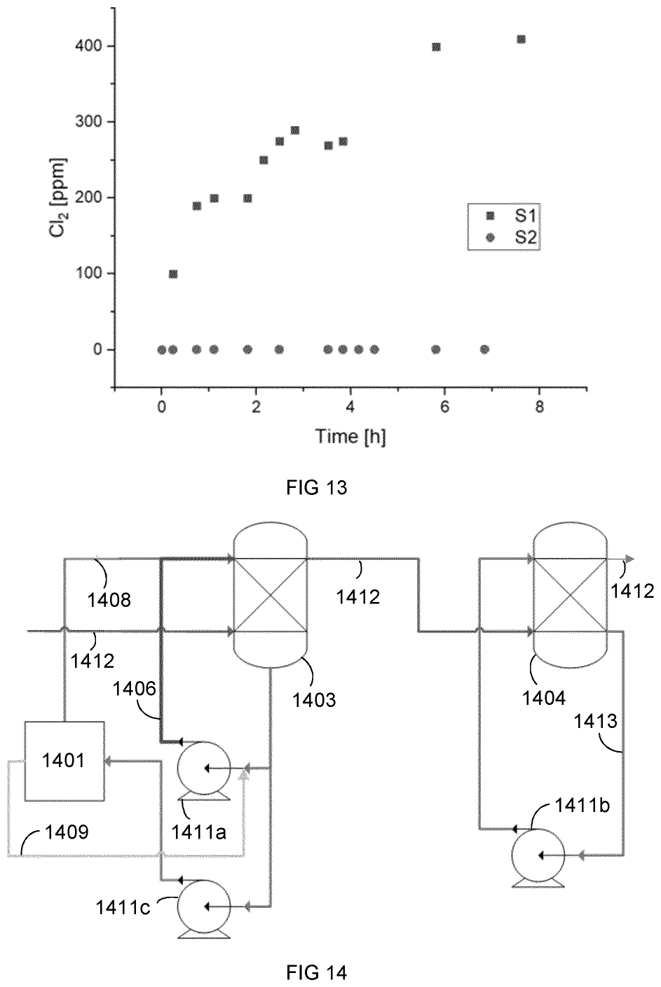

Using a current of 1.8 A, the system removed 800 ppm H₂S and the electrochemical cell produced excess Cl₂ gas. The Cl₂ gas was measured to reach a concentration of 400 ppm in the cleaned gas. A secondary scrubber with tap water was used to remove the Cl₂ gas. NaOH (s) was added to the solvent in the secondary scrubber. The secondary scrubber was capable of removing Cl₂ for more than 80 hours. FIG. 13 shows the content of Cl₂ in scrubber 1 outlet gas and scrubber 2 outlet gas as a function of time.

### Conclusion

A deliberate high current compared to H₂S flow was applied to the electrochemical cell in order to induce a transfer for chlorine to the desulfurized gas. This chlorine was successfully removed with tap water having been made basic with sodium hydroxide pellets. The introduction of sodium hydroxide to the water provided a higher capacity for removing chlorine compared to tap water. However, the liquid still had a finite capacity for removing Cl₂ before becoming saturated. These findings indicate the benefits of using alkaline, such as hydroxide ions, to remove Cl₂ from gas. These findings strongly indicate the benefits of generating aqueous alkali hydroxide for continuous scrubbing of Cl₂. Electrochemical generation of alkali hydroxide would eliminate the requirement of maintaining the system with regular refills of alkali hydroxide.

### Example 8: Removal of H₂S Using a Single Scrubber Setup

FIG. 3 shows a setup wherein a single scrubber is used for desulfurization of gas while keeping Cl₂ content in the desulfurized gas low. The first liquid circuit comprise a mixture of anolyte and catholyte, which is introduced upstream in the scrubber relative to the gas flow. A second liquid circuit comprise water or an aqueous solution of an alkali hydroxide. As an alternative embodiment, rather than using a combined flow of anolyte and catholyte, the anolyte may be introduced in the scrubber as shown on FIG. 3, whereas the catholyte may be fed to the second liquid circuit.

Based on the findings of examples 6 and 7, it is contemplated that such as setup is capable of efficiently desulfurize the gas while simultaneously keeping the content of Cl₂ in the purified gas low.

### Example 9: Removal of H₂S Using a Single Scrubber Setup

FIG. 4 shows a setup wherein a single scrubber is used for desulfurization of gas while keeping Cl₂ content in the desulfurized gas low. The primary liquid circuit comprise anolyte and catholyte which is generated in the electrochemical cell and introduced at a first scrubber inlet which is upstream of a second scrubber inlet relative to the gas flow. The scrubbing liquid is drained from the bottom of the scrubber, where part of the liquid is reintroduced on the scrubber at the second scrubber inlet. The other part of the liquid is either regenerated in the electrochemical cell or reintroduced directly to the scrubber at the first scrubber inlet. In one alternative embodiment, the anolyte and the catholyte may be separated in the electrochemical cell, and at least parts of the catholyte may be introduced at the second scrubber inlet.

Based on the findings of examples 6 and 7, it is contemplated that such as setup is capable of efficiently desulfurize the gas while simultaneously keeping the content of Cl₂ in the purified gas low.

### Example 10: Removal of H₂S Using a Dual Scrubber Setup

FIG. 5 shows a setup wherein setup comprising 2 scrubbers is used for desulfurization of gas while keeping Cl₂ content in the desulfurized gas low. The electrochemical cell generates anolyte and catholyte in separate chambers, after which the anolyte is fed to an inlet on a first scrubber. Part of the liquid outlet of the first scrubber is fed back to the electrochemical cell, whereas the other part is reintroduced directly on the first scrubber via a bypass. The catholyte is fed from the electrochemical cell to an inlet on a second scrubber. Part of the liquid out of the second scrubber is fed back to the electrochemical cell, whereas the other part is reintroduced directly on the second scrubber via a bypass.

The scrubbers may for example be positioned side by side, or they may be stacked, such as having the second scrubber stacked on top of the first scrubber.

Based on the findings of examples 6 and 7, it is contemplated that such as setup is capable of efficiently desulfurize the gas while simultaneously keeping the content of Cl₂ in the purified gas low.

### Example 11: Removal of H₂S Using a Dual Scrubber Setup

FIG. 6 shows a setup wherein setup comprising 2 scrubbers is used for desulfurization of gas while keeping Cl₂ content in the desulfurized gas low. The gas flow is first fed through a first scrubber, and then through a second scrubber. The electrochemical cell generates anolyte and catholyte, which are then fed to the first scrubber. The scrubbing liquid is drained from the first scrubber and introduced on a second scrubber. The scrubbing liquid is drained from the second scrubber, where parts of the liquid is fed back to the electrochemical cell and parts are fed directly to the liquid inlet of the first scrubber via a bypass. In an alternative embodiment, parts of the catholyte may bypass the first scrubber and be fed directly to the second scrubber. In one embodiment, parts of the liquid drained from the second scrubber may be directly reintroduced to the second scrubber, thus bypassing both the first scrubber and the electrochemical cell.

Based on the findings of examples 6 and 7, it is contemplated that such as setup is capable of efficiently desulfurize the gas while simultaneously keeping the content of Cl₂ in the purified gas low.

### Example 12: Further Assessment of Liquid Flow Influence on H₂S Removal Efficiency

### Materials and Methods

### Process Flow Diagram

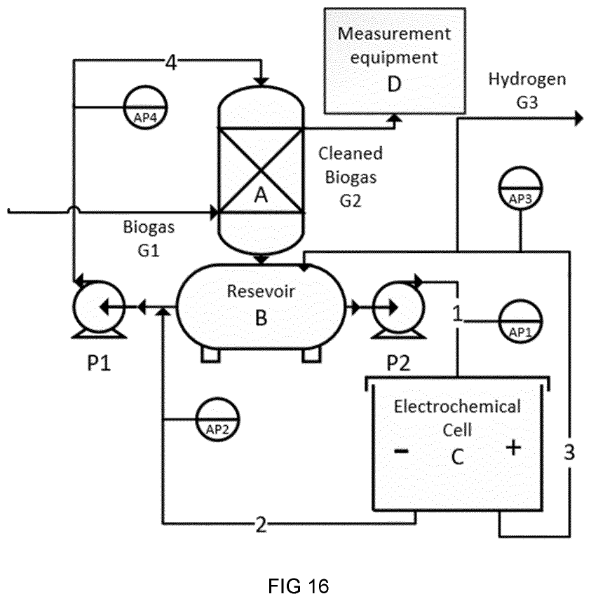

A process flow diagram of the system can be seen in FIG. 16. The setup used in the experimental work was, with the exception of sensors and electrodes, constructed entirely in plastic (PVC and PTFE) due to the highly corrosive and oxidative nature of the system. PVC was chosen since this plastic is already chlorinated. PVC is therefore highly resistant to oxidation from the high chlorine concentration present in the solvent.

During operation, electrical current was adjusted in order to achieve steady state conditions between 1-20 ppm H₂S in the outlet gas of the system. Several H₂S measurements were made at each steady state to ensure representative data.

### Packing Material

The scrubber column was filled with randomly stacked pall rings made from PVC. The rings has a surface area of 340 m²/m³ and a void fraction of 87%.

### pH and ORP Sensors

pH, temperature and redox measurement sensors from Bürkert were placed in the liquid flow before and after the scrubber unit, as well as on the inlet flow to the electrochemical cell, and in the outlet flow from each of the chambers of the electrochemical cell (AP1-4 in FIG. 16). As seen in FIG. 16, sensors were placed at four different locations of the system: AP1, The liquid flow going into the electrochemical cell; AP2 and AP3, the liquid flow going out of each of the chambers of the electrochemical cell; AP4, the liquid flow entering the top of the scrubber unit. The AP1 measurement is characterizing the liquid into the electrochemical cell. It is equivalent to the absorber bottom. The residence time of the liquid in the absorber bottom is in the order of 5-10 seconds. During normal operations, it is expected that the ORP (Oxidation Reduction Potential) measurements will show: AP2>AP4>AP1>AP3 due to the content of active oxidant in the liquid. The ORP was used as an indication of process performance.

### H₂S Measurement Equipment

After exiting the scrubber, the cleaned biogas was analyzed (see unit D in FIG. 16). The H₂S concentration was measured using an AWITE AWIECO electrochemical analyzer. The equipment contained two electrochemical sensors, which were capable of measuring in a range of 0-20 ppm and 0-1000 ppm, respectively. Since the low range sensor was more accurate, experiments were conducted so the outlet H₂S concentration was kept between 0 and 20 ppm whenever possible. The equipment measured the concentration every 15 minutes, but since only steady state data was desired, the infrequent measurements were not an issue. The H₂S concentration was supported by additional measurements using gas sampling tubes from Drager.

### Coriolis Mass Flow Controllers

The gas used in the experiments was a synthetic biogas consisting of H₂S, N₂ and CO₂. CH₄ is a main component of biogas, but during the initial setup and testing of the setup, it was found that the CH₄ in the gas phase is inert during the process. It was therefore replaced with an equal volume of nitrogen due to considerations of cost and safety. The flow of each of the component gasses was controlled by a Bronkhorst miniCori Coriolis flow controller (model M13V10I) in order to ensure accurate measurements. The gasses were mixed before entering the scrubber unit.

### Electrochemical Cell

A titanium oxide alloy was used for the electrodes. The chambers of the electrochemical cell were divided by a Nafion membrane, which allows water and cations to move through the membrane, but not anions. This ensured that the active chlorine was kept on the anode side of the cell. The liquid flow through the cell was kept high for all experiments as to reduce or eliminate influence by limitations in diffusion speed.

### Liquid Pumps

The flow of solvent through the scrubber unit was controlled by a Grundfoss membrane pump, which made it possible to adjust the solvent flow with a high degree of accuracy. The solvent flow through the electrochemical cell was achieved by using a smaller centrifugal pump. It was not possible to adjust the solvent flow with the centrifugal pump, why the precise solvent flow through the electrochemical cell is unknown. However, it was approximately 1 L/min for all experiments. The approximate flow rate through the electrochemical cell was measured with a measuring cup and a stopwatch. This flow rate is within the optimal operation parameters given by the supplier.

### Ion Chromatograph for Sulphate Measurement

To determine the contents of sulphate ions in the liquid of the scrubber, an ion chromatograph was used. This method measures the speed of the ions as they move through a charged resin. Ions with less affinity for the resin will move faster compared to ions with higher affinities. In this way the concentration of the ions can be determined by measuring the conductivity in the outlet liquid as it changes over time (D. C. Harris, Quantitative chemical analysis, 7th ed. New York N.Y.: W.H. Freeman and Co., 2007).

### Results

To examine the effect of the solvent flow through the scrubber, all process parameters were kept constant while the scrubber flow (flow 4 in FIG. 16) was gradually lowered from 500 L/h to 50 L/h. After each change in the pump flow setting, steady state was achieved before changing the pump flow again. The experimental parameters at steady state can be seen in Table 3 (C1.1-C1.4).

TABLE 3

| | Active | | | | | | |
|---|---|---|---|---|---|---|---|
| | comp. | | | | H₂S | | |
| | conc. | Packing | Solvent | Gas | inlet | | H₂S outlet |
| | (g/kg | height | flow | flow | conc. | | conc. |
| Campaign | water) | (m) | (L/h) | (g/h) | (ppm) | Curren t(I) | (ppm) |
| C1.1 | 50 | 0.5 | 500 | 450 | 487 | 1.6 | 5.69 |
| C1.2 | 50 | 0.5 | 250 | 450 | 487 | 1.6 | 6.54 |
| C.1.3 | 50 | 0.5 | 150 | 450 | 487 | 1.6 | 6.60 |
| C1.4 | 50 | 0.5 | 100 | 450 | 487 | 1.6 | 6.98 |
| C1.5 | 50 | 0.5 | 50 | 450 | 487 | 1.6 | 7.29 |
| C2.1 | 50 | 0.5 | 500 | 150 | 2000 | 2.4 | 14.2 |
| C2.2 | 50 | 0.5 | 500 | 225 | 2000 | 3.9 | 8.82 |
| C2.3 | 50 | 0.5 | 500 | 150 | 1000 | 0.9 | 14.15 |
| C2.4 | 50 | 0.5 | 500 | 225 | 1000 | 1.8 | 5.37 |
| C2.5 | 50 | 0.5 | 500 | 300 | 1000 | 2.4 | 12.5 |
| C2.6 | 50 | 0.5 | 500 | 450 | 1000 | 3.8 | 7.85 |
| C2.7 | 50 | 0.5 | 500 | 225 | 500 | 0.5 | 12.13 |
| C2.8 | 50 | 0.5 | 500 | 300 | 500 | 0.8 | 12.42 |
| C2.9 | 50 | 0.5 | 500 | 450 | 500 | 1.6 | 7.85 |
| C3.1 | 100 | 0.5 | 500 | 300 | 1654 | 3.59 | 25 |

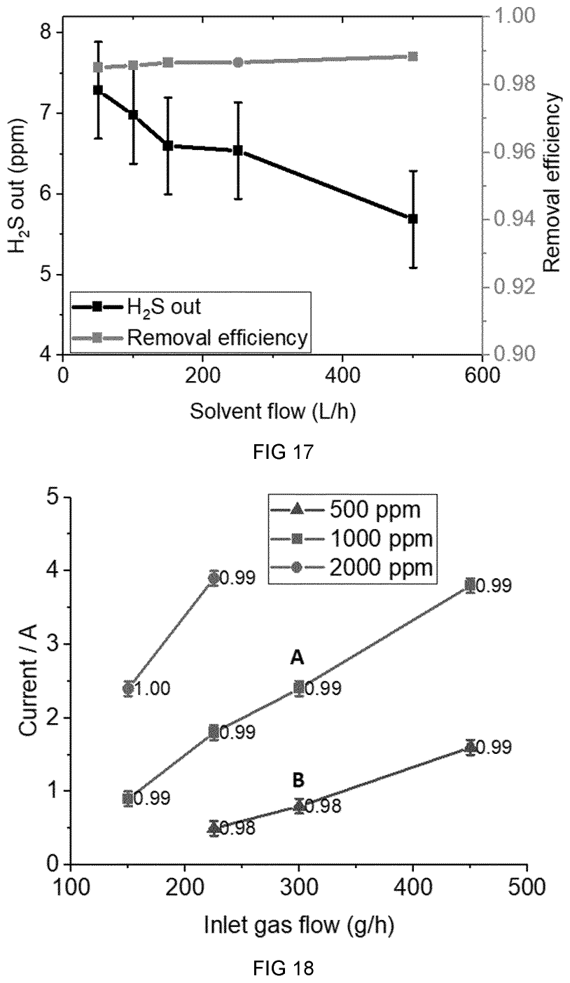

The results for the outlet H₂S concentration as a function of the solvent flow through the scrubber can be seen in FIG. 17. On the left Y-axis, the outlet H₂S concentration is plotted against the solvent flow. On the right Y-axis, the removal efficiency of the scrubber is plotted as a function of the solvent flow. At higher solvent flow rates, a minor decrease in the outlet H₂S concentration is observed. This change is approximately linear. However, compared to the inlet H₂S concentration of 1000 ppm, this removal percentage changes less than 0.5% at a 10 times increase in solvent flow.

The same amount of chlorine is needed for removing the H₂S, regardless of the solvent flow rate. It can therefore be assumed, that the concentration of chlorine in the solvent rises proportionally with the decrease in solvent flow rates. The concentration of chlorine at 50 L/h is therefore 10 times higher than the concentration at 500 L/h.

FIG. 17 also shows H₂S removal efficiency as defined in the equation:

$${e}_{R} = 1 - \frac{{n}_{{H}_{2} S , out}}{{n}_{{H}_{2} S , in}}$$

The removal efficiency can be adjusted by changing the amount of electrical current through the electrochemical cell. At a high current, the amount of chlorine produced will increase and more H₂S will be oxidized. At a low current, less H₂S will be oxidized since less chlorine is available for reaction.

The removal efficiency in the conducted experiment was purposefully set to be slightly below 1. Using the definition of current efficiency (equation below), the efficiency of the system is found to be approximately 0.26 for all solvent flow rates.

$${e}_{C} = \frac{{N}_{H 2 S} * {N}_{A} * 2}{I * C}$$

Where N_{H2S} is the amount of moles of H₂S removed per second, N_{A} is Avogadro's number, I is the current running through the electrochemical cell, and C is Coulombs number.

### Example 13: Further Assessment of Gas Flow on Scrubber Current Efficiency

### Materials and Methods

The setup was as described in Example 12.

### Results

Several gas flows and H₂S concentrations were tested in order to examine the effect of the gas flow on the scrubber system. The electrical current flowing through the electrochemical cell was adjusted, in order to achieve an outlet concentration between 1-20 ppm H₂S. The steady state values achieved during the experiments can be seen in Table 3 (C2.1-C2.9).

In FIG. 18 the applied current used to remove the H₂S is plotted versus the total inlet gas flow. The experiment was performed for three different H₂S gas concentrations and for a series of different gas flows. The experiments for 500, 1000 and 2000 ppm of H₂S are represented by the triangles, square, and circle icons, respectively. Experiments for a concentration of 2000 ppm were only done up to an inlet gas flow of 250 g/h.

The removal efficiency is 99%±1% for all steady state points. Constant removal efficiency was achieved by tuning the applied current to the electrochemical cell. From FIG. 18 it can be seen that the required current increases approximately linearly as function of gas flow. This is expected since there is a direct correlation between current use and removed H₂S. Comparing the H₂S concentrations, the current required for desulfurization also increases as a function of the H₂S concentration. The applied current needed for removing the H₂S did not seem to increase linearly with H₂S concentration, which is surprising. The reason for this may be that an increase in current, facilitates unwanted side reactions due to a proportional increase in chlorine concentration. This effect can be seen when comparing the steady state for 300 g/h of gas containing 1000 ppm of H₂S (A) to the steady state for 300 g/h of gas containing 500 ppm of H₂S (B) in FIG. 18. The total amount of H₂S at steady state A is twice the amount of steady state B. The required current for removing the H₂S, however, increases from 0.8 to 2.4 A between the two steady states. This suggests that three times as much electrical current was needed to remove twice the amount of H₂S.

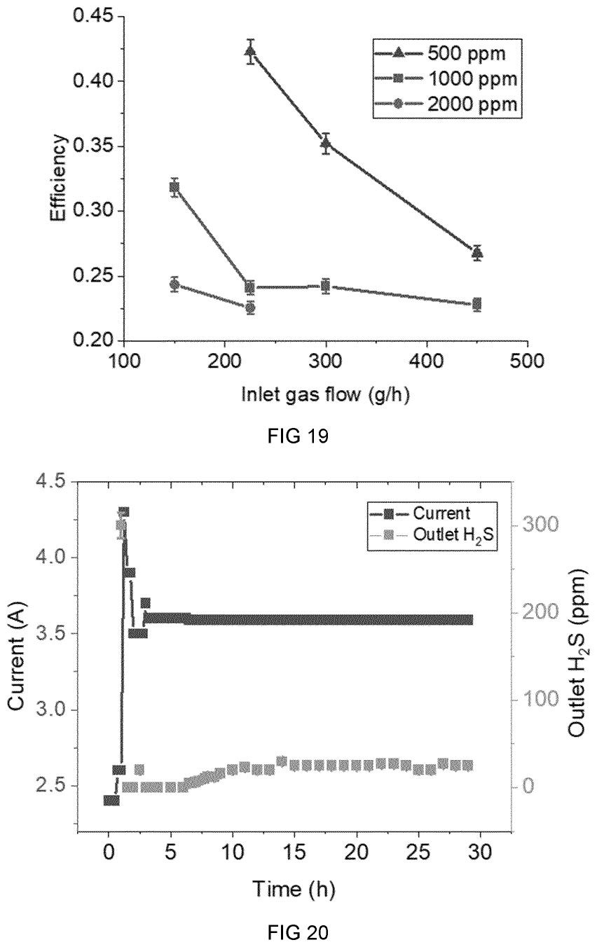

The influence of H₂S concentration on process performance can also be examined by calculating the current efficiency. This is indicated in FIG. 19 where the current efficiency is plotted versus the total gas flow rate for three different H₂S concentrations. The steady states used for this graph are the same as the ones seen in FIG. 18 and in Table 3 (C2.1-C2.9). It can be concluded that the current efficiency of the system decreases as the total gas flow rate increases for all three H₂S concentrations. When comparing the same inlet gas flow between the circle, triangle, and square data sets, it is seen, that the efficiency also decreases as a function of the H₂S concentration. The efficiency is likely dependent on the total amount of H₂S flowing through the scrubber, which can be calculated as the gas flow multiplied by the H₂S concentration.

In FIG. 19, the current efficiency is seen to decrease gradually as H₂S increases and reaches a minimum of approximately 22-23% for both 1000 ppm and 2000 ppm of H₂S. It is possible that the amount of H₂S does not directly impact the efficiency of the process. Rather, the increased current applied and active chlorine produced might have an adverse effect on the current efficiency. This efficiency loss can be explained by a large concentration of active chlorine facilitating unwanted side reactions, such as the formation of sulphate through oxidation of sulfur.

### Example 14: Long Term Test

### Materials and Methods

The setup of Example 12 was used.

### Results

To examine the long term stability of the system, a test of the laboratory setup was run for 30 hours. During this period the solvent flow, inlet gas flow, and H₂S concentrations were all kept stable. The steady state process parameters can be seen in Table 3 (C3.1). The results for the outlet H₂S concentration, as well as the current applied to the electrochemical cell, can be seen in FIG. 20. On the left Y-axis in FIG. 20, the current applied to the system is plotted as dark grey squares. During start-up, the current was initially changed slightly to find a suitable operating point. It was desired to achieve an outlet H₂S concentration of approximately 25 ppm. On the right Y-axis, the outlet H₂S concentration of the system is plotted versus time as light grey squares. From FIG. 20 it can be seen that a steady state was reached 10 hours into the experiment.

The system is seen to be stable at constant applied current with H₂S outlet concentrations deviating only up to 2 ppm during more than 20 hours of continuous operation. This deviation is less than 0.5% of the inlet concentration. During the entire experiment, the mean current efficiency of the process was calculated to be approximately 21%. During operation, pH decreased gradually from 8 to 0.5 during the initial 3 hours of the experiment. This decrease in pH is caused mainly by sulfuric acid formed by the absorption and subsequent oxidation of H₂S and sulfur. Absorption of CO₂ into the solvent will only play a minor role in the pH drop, since CO₂ is not captured at low pH values.

### Example 15: Further Assessment of Power Efficiency and Sulphate Formation

### Materials and Methods

The setup of Example 12 was used.

### Results

To determine the cause of the efficiency loss, an analysis of the liquid phase in the scrubber system was conducted. During the long term experiment, several liquid samples were extracted periodically. This was done to determine whether the elemental sulfur reacted with active chlorine to form sulphate. The sulphate content of the liquid samples was measured using an ion chromatograph. The oxidation from sulfur to sulphate when reacting with hypochlorous acid is:

$$3 HClO ( aq ) + S ( s ) + {H}_{2} O ( l ) \to {SO}_{4}^{2 -} ( a q ) + 3 {Cl}^{-} ( a q ) + 5 {H}^{+} ( a q )$$

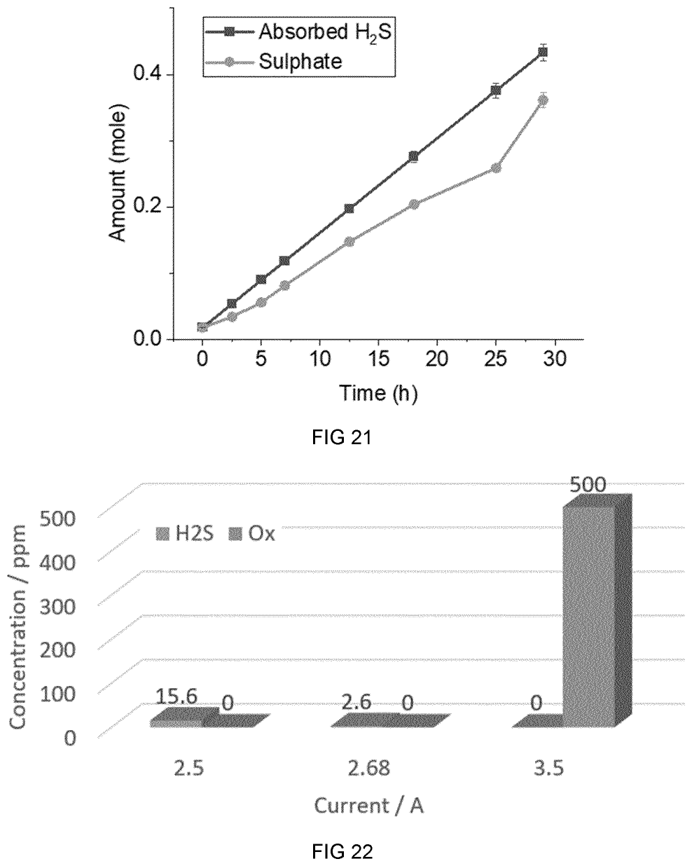

The sulphate concentration for the extracted liquid samples compared to the total amount of H₂S captured during the experiment, can be seen in FIG. 21.

The total amount of H₂S captured is represented by the dark grey line and increases almost completely linearly during operation. The linear progression is caused by both the inlet gas flow and capture rate being quite stable during the prolonged operation as seen in FIG. 20.

The amount of sulphate measured in the liquid samples is represented by the light grey line in FIG. 21. It is seen that the amount of SO₄²⁻ also increases almost linearly over time. This indicates that a portion of the active chlorine produced in the electrochemical cell is not used for oxidizing H₂S to elemental sulfur. Instead the chlorine is consumed by further oxidizing the elemental sulfur into sulphate.

Oxidation of sulfur to sulphate is seen to use three times as much active chlorine as the reaction from H2S to sulfur. Therefore, this reaction constitutes a considerable amount of the electrical current consumed in the cleaning process. In the long term experiment, the reaction from sulfur to sulphate consumed approximately 54% of the total current applied to the system. The oxidation of H₂S to sulfur consumed only 21%, leaving 25% currently unaccounted for. That a majority of the efficiency loss comes from formation of sulphate fits well with the observation that a large concentration of active chlorine leads to lower efficiency. A large concentration of chlorine may increase the reaction rate of unwanted sulfur oxidation, and thus lead to formation of additional sulphate and a loss of oxidant.

### Example 16: Further Assessment of Parameters

FIG. 22 shows the concentration of H₂S and oxidant in outlet gas as a function of current.

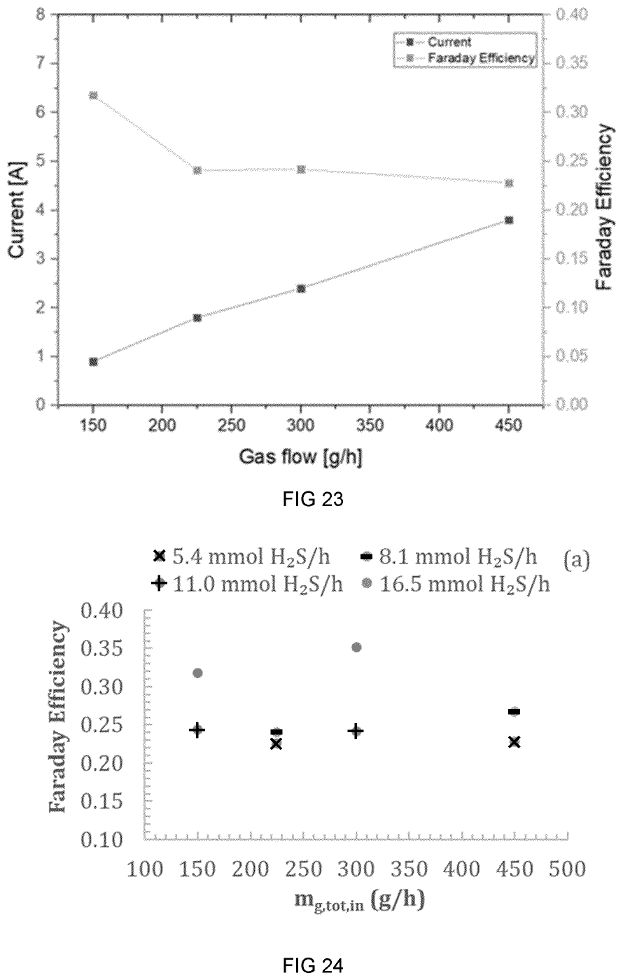

In the setup of Example 2, Faraday efficiency was assessed. FIG. 23 shows the Faraday efficiency as a function of gas flow, together with the corresponding currents employed. The Faraday efficiency was stable over a wide range of gas flows.

FIG. 24 shows the Faraday efficiency as a function of amount of H₂S and gas flow. The results show that Efficiency depends on H₂S amount, but not on gas flow rate. The results also show that the kinetics of the system is fast.

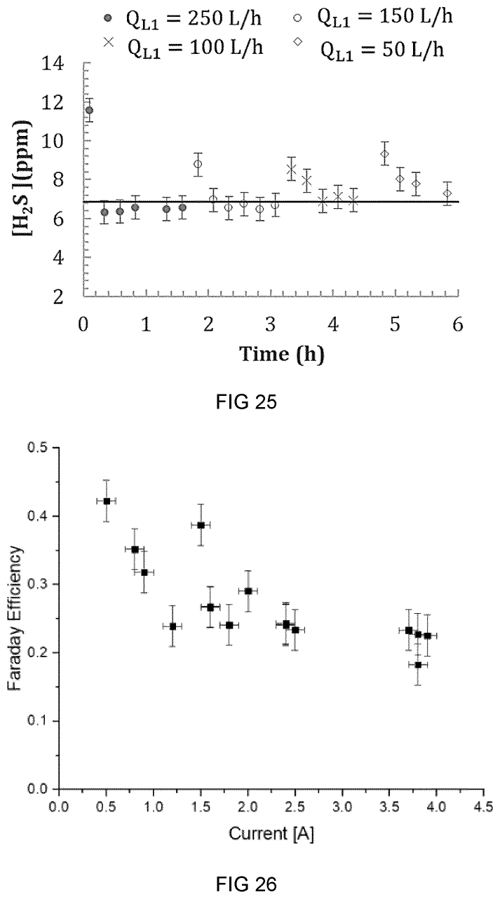

FIG. 25 shows the concentration of H₂S as a function of solvent flow rate. Current was kept constant.

FIG. 26 shows the Faraday efficiency as a function of current.

### Example 17: Desulfurisation in Gas-Gas Interface

### Materials and Methods

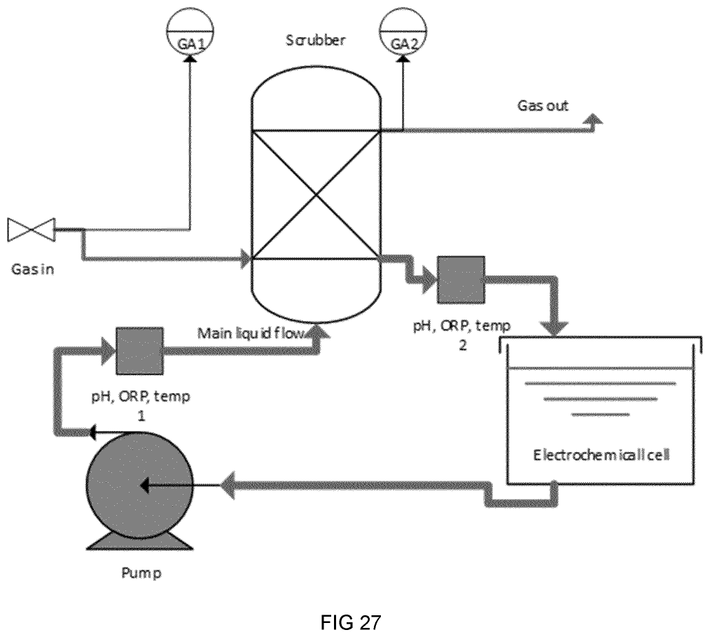

A process flow diagram of the set-up is presented in FIG. 27. Gas enters the scrubber in the bottom and leaves the scrubber in the top. The gas is analysed for H₂S before and after the scrubber. This scrubber is an empty vessel with no liquid flow and no packing. The liquid is situated at the bottom of the scrubber. A constant circulation pump is used to pump solvent through the electrochemical cell and back to the bottom of the scrubber. The liquid is analysed for ORP, pH and temperature before and after the electrochemical cell. Parameters that were kept constant throughout the experiments are presented in Table 4. Tables 5 and 6 outline the operating parameters for two different experiments referenced in the results section.

TABLE 4
Constant parameters used in the present study.

| Parameter | Symbol | Unit | Value | Comment |
|---|---|---|---|---|
| Scrubber | S | m | 0.1 | Laboratory scrubber |
| diameter | | | | |
| Scrubber | H | m | 0.3 | Laboratory scrubber |
| height | | | | |
| Gas | Pg | kg/m3 | 1.135 | Calculated, Ideal gas law at |
| density | | | | 20° C. and 1 bar for 40% |
| | | | | CO2, 60% CH4, and 2000 |
| | | | | ppm H2S |
| Liquid | Pl | kg/m3 | 1075.6 | Water density with 10 w % |
| density | | | | NaCl |
| Molar mass | Mg | g/mol | 27.3 | Calculated from the average |
| of gas | | | | molar mass of 60% CH4, |
| | | | | 40% CO2, and 2000 ppm |
| | | | | H2S |
| Temperature | T | ° C. | Room | |
| Surface area | T | m2 | 0.02 | |
| of electrodes | | | | |

TABLE 5
Experiment A: Parameters to confirm gas to
gas reaction. Experiment: constant current

| Operating parameter | Value | |
|---|---|---|
| Salt solution concentration [NaCl in | 100 | g/L |
| water] | | |
| Gas flow, N₂, CO₂, H₂S @19900 ppm | 176, 110, 13.7 g/hr | |
| Inlet H₂S gas concentration | 1045 | ppm |
| Liquid flow through scrubber | 0 | L/hr |
| Applied current density in the cell | 70 | A/m² |

| | |
|---|---|
| Packing material | No packing material |
| Removal efficiency | 21.6-63.7% |
| Observed faraday efficiency | 23.7% |
| Configuration | Gas-to-gas reaction |

TABLE 6
Experiment B: Control ORP of the
solvent. varying applied current.

| Operating parameter | Value | |
|---|---|---|
| Salt solution concentration [NaCl in | 100 | g/L |
| water] | | |
| Gas flow, N₂, CO₂, H₂S @19900 ppm | 176, 110, 13.7 g/hr | |
| Inlet H₂S gas concentration | 1045 | ppm |
| Liquid flow through scrubber | 0 | L/hr |
| Applied current density in the cell | 70-125 | A/m² |

| | |
|---|---|
| Packing material | No packing material |
| Removal efficiency | 52.0-82.4% |
| Observed faraday efficiency | 17.3-31.2% |
| Configuration | Gas-to-gas reaction |

### Results

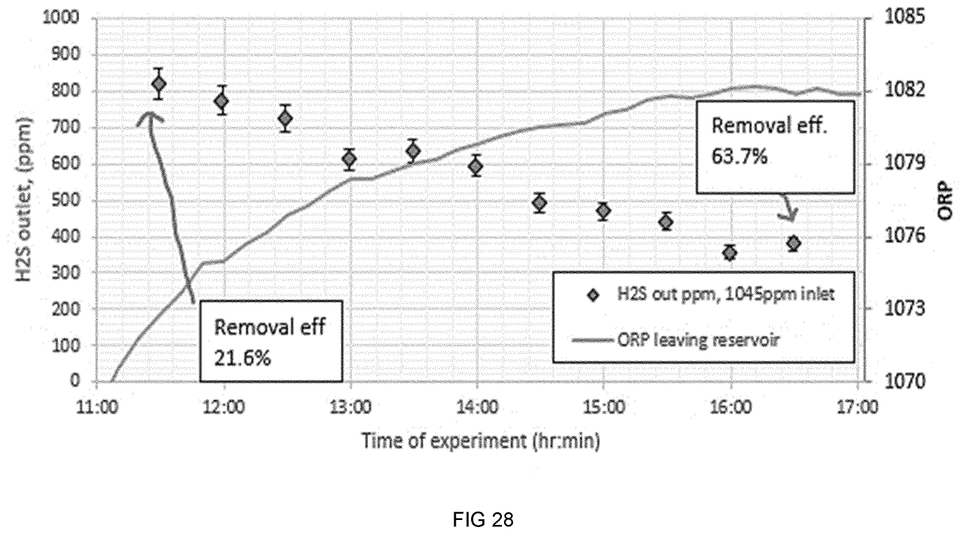

In experiment A, the gas-gas reaction of C₂ and H₂S is observed. Results from the experiment is presented in FIG. 28. On the left y-axis, the hydrogen sulfide concentration in the outlet gas is presented as parts per million of the gas molecules. The right y-axis show the oxidation reduction potential in mV. The x-axis show the time, starting at 11:00 and ending at 17:00. The diamonds indicate the hydrogen sulfide concentration in the outlet gas as a function of time. The line indicate the ORP of the solvent leaving the reservoir in the bottom of the scrubber. It is observed, that the outlet concentration of hydrogen sulfide decreases as a function of time, from more than 800 ppm to 400 ppm. The ORP value of the solvent is observed to increase within the same timeframe, from less than 1070 to 1082. All parameters were kept constant throughout the experiment, with a concentration of 1045 ppm hydrogen sulfide in the inlet gas. The decrease in hydrogen sulfide concentration can be directly linked with an increase in removal efficiency. In FIG. 2, the removal efficiency has been calculated at the start and at the end of the experiment. The value indicate that the removal efficiency increases from 21.6% to 63.7%. Overall, the hydrogen sulfide concentration is observed to decrease as the current is applied. The development of the hydrogen sulfide concentration in the outlet gas correlates very well with the ORP of the solvent. Both the value of the ORP and the hydrogen sulfide concentration is observed to stabilize over time. Based on the experiment, a stabilization time in the order of 5 hours is expected.

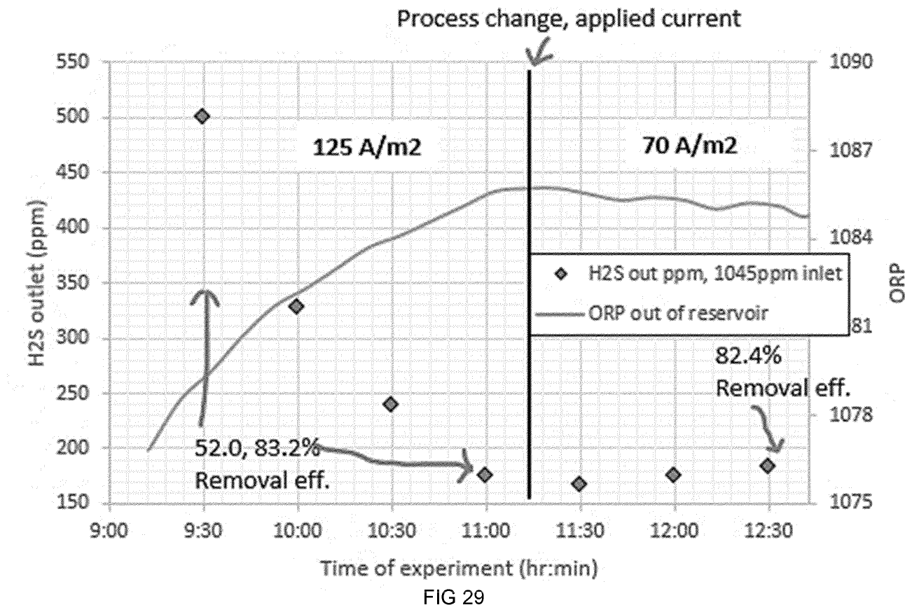

In experiment B, the effect of changing the applied current was investigated. In FIG. 29, the results from experiment B is presented. On the left y-axis, the hydrogen sulfide concentration in the outlet gas is presented as a concentration: parts per million of the gas molecules. The right y-axis show the oxidation reduction potential in mV. The x-axis show the time, starting at 9:00 and ending at 12:30. The diamonds indicate the hydrogen sulfide concentration in the outlet gas as a function of time. The line indicate the ORP of the solvent leaving the reservoir in the bottom of the scrubber. At 11:15, a the vertical line indicates that the applied current was changed. At this time, the current was decreased from 125 A/m2 to 70 A/m2. The other parameters were kept constant throughout the experiment. From FIG. 29, it is observed that the hydrogen sulfide concentration decreases drastically from 500 ppm at 09:30 to 175 ppm at 11:00. This corresponds to an increase in removal efficiency from 52% to 83.2%. At the same time, the ORP of the solvent is observed to increase from 1077 mV to 1086 mV. Following the change in applied current, the ORP value and the hydrogen sulfide concentration are observed to change behaviour. The hydrogen sulfide concentration is observed to increase slightly, going from 170 ppm at 11:30 to 185 ppm at 12:30. Similarly, the ORP value decreases from 1086 mV at 11:15 to 1085 mV at 12:30. The removal efficiency is also observed to decrease resulting in a value of 82.4% at 12:30.

From experiment B, it can be observed that when changing the applied current, the removal of hydrogen sulfide also changes. Specifically, it can be observed that there is a point where the development of hydrogen sulfide removal and ORP value of the solvent changes direction. Furthermore, it can be observed that the changes to the ORP value and the hydrogen sulfide concentration is not independent on the conditions of the solvent. The ORP value and hydrogen sulfide concentration changes much more slowly after the change in current at 11:15 than before.

Solid sulfur was observed to form inside the scrubber during experiments A and B as precipitates deposited on the inner surface of the scrubber. Following the experiments, samples of the solid sulfur was collected and analysed using a scanning electrode microscope (SEM) equipped with energy dispersive x-ray spectroscopy (EDS).

The solid samples consisted of small particles. The sample consisted of 93% sulfur with some sodium (4%) and chlorine (3%). The sodium and chlorine are most likely traces of the solvent found in the sulfur. The sample was prepared on carbon tape to ensure conductivity, and the carbon content of the sample has therefore been subtracted. Carbon is not expected to be found in the solid sulfur sample.

### Conclusion

In conclusion, it is possible to remove hydrogen sulfide from a gas using only chlorine gas. The chlorine gas in these experiments were emitted from a low pH-value solvent containing high concentrations of active chlorine. The active chlorine was generated in an electrochemical cell. The active chlorine and hydrogen sulfide reacted inside a scrubber where the packing had been removed.

The results were confirmed in a series of experiments, and through analysis of a series of values. The behaviour could be observed both from the hydrogen sulfide concentration and through the oxidation reduction potential of the solvent.

The results show that a significant period of time is required for the system to stabilize. Furthermore, solid sulfur is observed to form at the sides of the scrubber. This results was confirmed through analysis of solid samples collected from the scrubber. The samples were analysed with a scanning electrode microscope equipped with energy dispersive x-ray spectroscopy. The solid was found to have a sulfur concentration of 93% with traces of sodium chloride consisting of the remaining 7%.

### Example 18: Pilot Plant Experiments on Real Biogas

### Materials and Methods

Set-up: power supply from 0-12 V, 0-300 A, electrochemical cell 0.16 m² electrode areas, membrane proton exchange, scrubber 0280 mm, height 100 cm, full-cone spray nozzle, random packing elements Raschig Pall rings 15 mm×15 mm,

4 pumps were used: Anode flow of 320-1020 L/h, another pump for the cathode flow of 60-780 L/h, another for scrubber 1 with a flow of 0-1440 L/h and the last for scrubber 2 with a flow of 270-690 L/h.

The split configuration were used, there the anode flow of the electrochemical cell were used in scrubber 1 and the cathode flow were used in scrubber 2.

The assessment was conducted at using a current of 10-90 A and a voltage of 2.7-3.6 V. A total liquid volume of 12 L was circulated in the system having an initial NaCl concentration of 100 g/L. The gas flow was varied from 6-13.4 Nm³/h. The H₂S concentration varied in the biogas between 866-1633 ppm. Removal down to 0 ppm was achieved.

### Results

| Active | | | | | | |
|---|---|---|---|---|---|---|
| comp. | Packing | Solvent | Gas | Inlet | | Outlet |
| conc. | height | flow | Flow | H₂S | Current | H₂S |
| (g/kg water) | (m) | (L/h) | (m3/h) | (ppm) | (A) | (ppm) |
| 100 | 1 | 720 | 9 | 1112 | 10.2 | 1027 |
| 100 | 1 | 720 | 9.7 | 1098 | 20.2 | 772 |
| 100 | 1 | 720 | 9.6 | 1125 | 40.2 | 401 |
| 100 | 1 | 720 | 10 | 1125 | 60.2 | 20 |
| 100 | 1 | 720 | 9.6 | 1040.5 | 60.2 | 0 |
| 100 | 1 | 720 | 9.5 | 992 | 64.3 | 0 |
| 100 | 1 | 720 | 9.6 | 999 | 70.3 | 20 |
| 100 | 1 | 720 | 9.8 | 1088 | 74.3 | 16 |
| 100 | 1 | 960 | 9.4 | 1115 | 64.3 | 10 |
| 100 | 1 | 960 | 9.5 | 1062 | 70.3 | 10 |
| 100 | 1 | 960 | 9.8 | 1070 | 74.3 | 10 |
| 100 | 1 | 960 | 9.3 | 866 | 60.2 | 5 |
| 100 | 1 | 960 | 9.5 | 898 | 40.2 | 117.1 |
| 100 | 1 | 960 | 9.5 | 1037 | 40.2 | 307.5 |
| 100 | 1 | 960 | 9.4 | 1002 | 40.2 | 234.92 |
| 100 | 1 | 1380 | 9.8 | 1006 | 40.2 | 218.246 |
| 100 | 1 | 540 | 10 | 1006 | 40.2 | 77 |
| 100 | 1 | 540 | 7.7 | 904 | 40.2 | 3 |
| 100 | 1 | 540 | 9.4 | 1032 | 40.2 | 494 |
| 100 | 1 | 960 | 9 | 1090 | 40.2 | 514 |
| 100 | 1 | 1380 | 9.3 | 1087 | 40.2 | 519 |
| 100 | 1 | 960 | 7.7 | 1022 | 40.2 | 21.6 |
| 100 | 1 | 960 | 10 | 997 | 64.3 | 28.67 |
| 100 | 1 | 960 | 6 | 994 | 34.2 | 307 |
| 100 | 1 | 960 | 9.2 | 991 | 40.2 | 470 |
| 100 | 1 | 960 | 11 | 1030 | 40.1 | 700 |
| 100 | 1 | 1020 | 11.63 | 1362 | 10.1 | 1279 |
| 100 | 1 | 990 | 12.14 | 1326 | 20.2 | 1162 |
| 100 | 1 | 990 | 11.84 | 1259 | 30.2 | 916 |
| 100 | 1 | 960 | 13.15 | 1239 | 40.1 | 683 |
| 100 | 1 | 900 | 12.73 | 1158 | 60.2 | 349 |
| 100 | 1 | 1410 | 12.13 | 1316 | 74.2 | 301 |
| 100 | 1 | 1230 | 13.37 | 1326 | 74.3 | 249 |
| 100 | 1 | 990 | 11.25 | 1633 | 74.2 | 518 |
| 100 | 1 | 720 | 10.55 | 1479 | 74.3 | 620 |
| 100 | 1 | 180 | 11.24 | 1605 | 74.3 | 735 |
| 100 | 1 | 720 | 10.5 | 1552 | 74.3 | 507 |
| 100 | 1 | 750 | 10.5 | 1552 | 74.3 | 270 |
| 100 | 1 | 0 | 9.4 | 1377 | 40.2 | 450 |
| 100 | 1 | 0 | 9.4 | 1431 | 20.1 | 938 |
| 100 | 1 | 0 | 8.8 | 1431 | 20.1 | 564 |
| 100 | 1 | 930 | 10 | 1478 | 90.4 | 194 |
| 100 | 1 | 900 | 9.9 | 1421 | 90.4 | 127 |
| 100 | 1 | 540 | 10.3 | 1449 | 84.3 | 20 |
| 100 | 1 | 660 | 8.56 | 1525 | 74.3 | 302 |
| 100 | 1 | 679.8 | 8.6 | 1523 | 74.3 | 179 |
| 100 | 1 | 379.8 | 8.83 | 1409 | 74.2 | 230 |
| 100 | 1 | 960 | 9.6 | 1475 | 90.4 | 74.25 |
| 100 | 1 | 840 | 10.3 | 1365 | 90.4 | 28.67 |
| 100 | 1 | 1410 | 9.5 | 1382 | 40.2 | 493 |
| 100 | 1 | 1410 | 8.8 | 1298 | 44.2 | 161.8 |
| 100 | 1 | 1440 | 8.7 | 1298 | 44.2 | 158.8 |
| 100 | 1 | 1410 | 8.4 | 1298 | 44.2 | 8 |
| 100 | 1 | 1410 | 8.47 | 1429 | 60.2 | 156 |
| 100 | 1 | 585 | 10.25 | 1387 | 60.2 | 273 |
| 100 | 1 | 1410 | 10.8 | 1543 | 60.2 | 250 |
| 100 | 1 | 1416 | 9.75 | 1517 | 90.3 | 49.75 |
| 100 | 1 | 1399.8 | 9.03 | 1460 | 30.2 | 961 |
| 100 | 1 | 1399.8 | 10.87 | 1358 | 34.2 | 907 |
| 100 | 1 | 1350 | 12.23 | 1392 | 50.2 | 470 |
| 100 | 1 | 1230 | 10.4 | 1283 | 58.2 | 208 |
| 100 | 1 | 1110 | 10 | 1353 | 64.2 | 83 |

### Conclusion

The process has been showed to remove H₂S from raw biogas in different settings.

The result include process parameters that can easily be scaled up.

The results include a recreation of the gas-gas reaction showed in the laboratory.

1. A system for cleaning of gas, said system comprising:
i. an electrolysis element comprising separate anolyte- and catholyte compartments for generation of an anolyte and a catholyte, respectively, and
ii. a wet scrubbing element comprising:
a gas inlet and a gas outlet defining the direction of the gas flow;
an anolyte inlet and a catholyte inlet, wherein the catholyte inlet is separate and downstream from the anolyte inlet relative to the direction of the gas flow; and
one or more scrubbing liquid outlets
said one or more scrubbing liquid outlets being configured to at least in part supply the electrolysis element.

2. The system according to claim 1 further comprising an electrolysis element bypass between the one or more scrubbing liquid outlets and the anolyte inlet and/or catholyte inlet.

3. The system according to any one of the preceding claims, wherein the electrolysis element bypass is configured to transfer liquid from the scrubbing liquid outlets to the anolyte inlet and/or the catholyte inlet by bypassing the electrolysis element.

4. The system according to any one of the preceding claims, further comprising:
i. a liquid transferring element from the anolyte compartment to the anolyte inlet,
ii. a liquid transferring element from the catholyte compartment to the catholyte inlet, and/or
iii. one liquid transferring element from each of the one or more scrubbing liquid outlets to the electrolysis element.

5. The system according to any one of the preceding claims, further comprising:
i. a liquid transferring element from the anolyte compartment to the anolyte inlet,
ii. a liquid transferring element from the catholyte compartment to the catholyte inlet, and
iii. one or more liquid transferring elements from the one or more scrubbing liquid outlets to the electrolysis element.

6. The system according to any one of the preceding claims, comprising two wet scrubbing elements connected in series with respect to the gas flow.

7. The system according to any one of the preceding claims, wherein the cleaning of gas is desulfurisation of gas.

8. The system according to any one of the preceding claims, said system being configured to desulfurise gas.

9. The system according to any one of the preceding claims, wherein the desulfurisation of gas is the full or partial removal of one or more sulfur compounds from the gas.

10. The system according to any one of the preceding claims, wherein the system is configured to full or partial removal of one or more sulfur compounds from the gas.

11. The system according to any one of the preceding claims, wherein the desulfurisation of gas is the reduction of H₂S content in the gas.

12. The system according to any one of the preceding claims, wherein the gas is a fuel gas, such as coke-oven gas, natural gas, gas from geothermal plants, shale gas, or landfill gas.

13. The system according to any one of the preceding claims, wherein the gas is selected from the group consisting of process gas from the production of bio-technical products and exhaust gas from chemical factories.

14. The system according to any one of the preceding claims, wherein the electrolysis element comprises a single liquid inlet supplying both the anolyte compartment and the catholyte compartment.

15. The system according to any one of the preceding claims, wherein the electrolysis element comprises a single liquid inlet configured to supply both the anolyte compartment and the catholyte compartment.

16. The system according to any one of the preceding claims, wherein the electrolysis element comprises one liquid inlet supplying the anolyte compartment and another liquid inlet supplying the catholyte compartment.

17. The system according to any one of the preceding claims, wherein the electrolysis element comprises one liquid inlet configured to supply the anolyte compartment and another liquid inlet supplying the catholyte compartment.

18. The system according to any one of the preceding claims, wherein the one or more wet scrubbing elements are one or more wet scrubbing towers.

19. The system according to any one of the preceding claims, comprising a wet scrubbing element having a scrubbing liquid outlet, wherein said scrubbing liquid outlet is positioned between the anolyte inlet and the catholyte inlet.

20. The system according to any one of the preceding claims, wherein the scrubbing liquid outlet supply the wet scrubbing element at the anolyte inlet.

21. The system according to any one of the preceding claims, wherein the scrubbing liquid outlet is configured to supply the wet scrubbing element at the anolyte inlet.

22. The system according to any one of the preceding claims, wherein the scrubbing liquid outlet supply the wet scrubbing element at the catholyte inlet.

23. The system according to any one of the preceding claims, wherein the scrubbing liquid outlet is configured to supply the wet scrubbing element at the catholyte inlet.

24. The system according to any one of the preceding claims, wherein the scrubbing liquid outlet supply both the electrolysis element and the wet scrubbing element at the anolyte inlet.

25. The system according to any one of the preceding claims, wherein the scrubbing liquid outlet is configured to supply both the electrolysis element and the wet scrubbing element at the anolyte inlet.

26. The system according to any one of the preceding claims, wherein the scrubbing liquid outlet supply both the electrolysis element and the wet scrubbing element at the catholyte inlet.

27. The system according to any one of the preceding claims, wherein the scrubbing liquid outlet is configured to supply both the electrolysis element and the wet scrubbing element at the catholyte inlet.

28. The system according to any one of the preceding claims, wherein part of the catholyte, but not all of the catholyte, is being introduced to the wet scrubbing element at the anolyte inlet.

29. The system according to any one of the preceding claims, wherein the system is configured to introduce part, but not all of the catholyte, to the wet scrubbing element at the anolyte inlet.

30. The system according to any one of the preceding claims, wherein:
i. the system comprises a first wet scrubbing element and a second wet scrubbing element,
ii. the anolyte compartment supplies a first wet scrubbing element at its anolyte inlet,
iii. the catholyte compartment supplies a second wet scrubbing element at its catholyte inlet,
iv. the liquid outlet of the first wet scrubbing element supplies the electrolysis element and the anolyte inlet of the first wet scrubbing element, and
v. the liquid outlet of the second wet scrubbing element supplies the electrolysis element and the catholyte inlet of the second wet scrubbing element.

31. The system according to any one of the preceding claims, wherein:
i. the system comprises a first wet scrubbing element and a second wet scrubbing element,
ii. the anolyte compartment is configured to supply a first wet scrubbing element at its anolyte inlet,
iii. the catholyte compartment is configured to supply a second wet scrubbing element at its catholyte inlet,
iv. the liquid outlet of the first wet scrubbing element is configured to supply the electrolysis element and the anolyte inlet of the first wet scrubbing element, and
v. the liquid outlet of the second wet scrubbing element is configured to supply the electrolysis element and the catholyte inlet of the second wet scrubbing element.

32. The system according to any one of the preceding claims, wherein the one or more wet scrubbing elements are two wet scrubbing towers.

33. The system according to any one of the preceding claims, wherein the one or more wet scrubbing elements is a single wet scrubbing tower.

34. The system according to any one of the preceding claims comprising a single wet scrubbing tower, wherein the catholyte inlet is positioned downstream of the anolyte inlet relative to the direction of the gas flow.

35. The system according to any one of the preceding claims, wherein the single scrubbing tower comprises a single scrubbing liquid outlet upstream of the anolyte inlet.

36. The system according to any one of the preceding claims, wherein the single scrubbing tower comprises a scrubbing liquid outlet between the catholyte inlet and the anolyte inlet, and a further scrubbing liquid outlet upstream of the anolyte inlet.

37. The system according to any one of the preceding claims comprising a first wet scrubbing element and a second wet scrubbing element, and wherein the direction of the gas flow is from the first wet scrubbing element to the second wet scrubbing element.

38. The system according to any one of the preceding claims, wherein the electrolysis element consumes 4.0 to 9.0 A per g H₂S in the gas per hour, such as 5.0 to 7.4 A per g sulfur per hour, such as 5.2 to 7.2 A per g sulfur per hour, such as 5.4 to 7.0 A per g sulfur per hour, such as 5.6 to 6.8 A per g sulfur per hour, such as 5.8 to 6.6 A per g sulfur per hour, such as 6.0 to 6.4 A per g sulfur per hour, such as about 6.2 or 6.3 A per g sulfur per hour.

39. The system according to any one of the preceding claims, wherein the electrolysis element is configured to consume 4.0 to 9.0 A per g H₂S in the gas per hour, such as 5.0 to 7.4 A per g sulfur per hour, such as 5.2 to 7.2 A per g sulfur per hour, such as 5.4 to 7.0 A per g sulfur per hour, such as 5.6 to 6.8 A per g sulfur per hour, such as 5.8 to 6.6 A per g sulfur per hour, such as 6.0 to 6.4 A per g sulfur per hour, such as about 6.2 or 6.3 A per g sulfur per hour.

40. The system according to any one of the preceding claims, wherein the electrolysis element is an electrochemical cell.

41. The system according to any one of the preceding claims further comprising one or more filters.

42. The system according to any one of the preceding claims, wherein the filter is positioned after the liquid outlet to a wet scrubbing element, such as after the wet scrubbing element to which the anolyte is supplied.

43. The system according to any one of the preceding claims, wherein the filter is positioned at or after the liquid outlet of the one or more wet scrubbing elements.

44. The system according to any one of the preceding claims, further comprising one or more pumps, such as:
i. a pump prior to the electrolysis element,
ii. a pump after the liquid outlet of one wet scrubbing element,
iii. a pump prior to the anolyte inlet,
iv. a pump prior to the catholyte inlet,
v. a pump prior to the gas inlet,
vi. a pump after the electrolysis element.

45. The system according to any one of the preceding claims, further comprising one or more filters, such as
i. a filter prior to the electrolysis element,
ii. a filter after the liquid outlet of one wet scrubbing element,
iii. a filter prior to a pump,
iv. a filter prior to the anolyte inlet,
v. a filter prior to the catholyte inlet, and/or
vi. a filter after the electrolysis element.

46. The system according to any one of the preceding claims, wherein the filter is a membrane filter or an ion chromatograph.

47. A fuel gas processing plant comprising the system according to any one of the preceding claims.

48. A method for desulfurisation of gas, said method comprising the steps of:
i. providing an electrolysis element comprising separate compartments for generation of an anolyte and a catholyte,
ii. providing one or more wet scrubbing elements,
iii. providing a scrubbing liquid comprising an alkali chloride,
iv. providing a gas comprising a sulfur compounds,
v. conducting a electrochemical conversion of said scrubbing liquid to produce a anolyte comprising an oxidising agent and a catholyte comprising a base,
vi. conducting a first scrubbing of said gas by contacting said gas with said anolyte in one wet scrubbing element, thereby obtaining a desulfurised gas and a spent scrubbing liquid, and conducting a second scrubbing of said gas by contacting said gas with said catholyte, thereby obtaining a desulfurised and dechlorinated gas and a spent scrubbing liquid, wherein the second scrubbing is conducted downstream of the first scrubbing relative to the direction of the gas flow.
vii. recycling the spent scrubbing liquid by
a. supplying at least parts of the spent scrubbing liquid to the electrolysis element.

49. The method according to claim 48, wherein step vii. further comprises a step of:
b. supplying at least parts of the spent scrubbing liquid directly to the wet scrubbing elements by bypassing the electrolysis element.

50. The method according to any one of the preceding claims, wherein the sulfur compound is H₂S.

51. The method according to any one of the preceding claims, wherein the content of H₂S in the gas comprising the sulfur compound is 10 to 20000 ppm, such as 10 to 5000 ppm, such as 100 to 4000 ppm, such as 500 to 2500 ppm.

52. The method according to any one of the preceding claims, wherein the content of H₂S in the gas comprising the sulfur compound varies substantially depending on feedstock composition and/or other external parameters such as temperature.

53. The method according to any one of the preceding claims, wherein said variation in H₂S content is of a type such that a method comprising no introduction of catholyte would be insufficient to ensure removal of H₂S without introducing Cl₂ to the gas.

54. The method according to any one of the preceding claims, wherein said variation in H₂S content is of a type such that a method comprising no introduction of catholyte would be insufficient to ensure removal of H₂S without introducing Cl₂ to the gas unless the current applied to the electrolysis element was continuously to accommodate the varying content of H₂S.

55. The method according to any one of the preceding claims, wherein the method can tolerate a 100% variation in the content of H₂S in the gas comprising sulfur compounds while still removing substantially all H₂S from the gas and without introducing substantially any Cl₂ to the gas.

56. The method according to any one of the preceding claims, wherein the method can tolerate a 100% variation in the content of H₂S in the gas comprising sulfur compounds while still removing substantially all H₂S from the gas and without introducing substantially any Cl₂ to the gas, and without varying the current applied to the electrolysis element.

57. The method according to any one of the preceding claims, wherein no adjustment of the voltage and/or current supplied to electrolysis element is required to accommodate a 100% variation of H₂S content in the gas.

58. The method according to any one of the preceding claims, wherein the alkali chloride is NaCl, KCl, and/or LiCl.

59. The method according to any one of the preceding claims, wherein the alkali chloride is NaCl.

60. The method according to any one of the preceding claims, wherein the scrubbing liquid comprises between 1 and 300 g/L NaCl, such as between 200 and 300 g/L NaCl, between 1 and 300 g/L KCl, such as between 200 and 300 g/L KCl, and/or between 1 and 300 g/L LiCl, such as between 200 and 300 g/L LiCl.

61. The method according to any one of the preceding claims, wherein the method does not comprise a step of adding NaOH, NaClO, HClO, or Cl₂ to the scrubbing liquid.

62. A method of desulfurising a gas, said method comprising using the system according to any one of the preceding claims.

63. A system configured for performing the method according to any one of the preceding claims.

64. A gas desulfurised using the method according to any one of the preceding claims.

65. The gas according to any one of the preceding claims comprising:
i. less than 100 ppm H₂S, such as less than 75 ppm H₂S, such as less than 50 ppm H₂S, such as less than 25 ppm H₂S, such as less than 20 ppm H₂S, such as less than 15 ppm H₂S, such as less than 10 ppm H₂S, such as less than 5 ppm H₂S, and
ii. less than 100 ppm Cl₂, such as less than 75 ppm Cl₂, such as less than 50 ppm Cl₂, such as less than 25 ppm Cl₂, such as less than 20 ppm Cl₂, such as less than 15 ppm Cl₂, such as less than 10 ppm Cl₂, such as less than 5 ppm Cl₂.
